(19) United States
(12) Patent Application Publication
(10) Pub. No.: US 2024/0017268 A1
(43) Pub. Date: Jan. 18, 2024

(54) Apparatus, Systems, and Methods for Detecting and Modeling Mill Charge Behavior

(71) Applicant: Moly-Cop USA LLC, Omaha, NE (US)

(72) Inventor: Ian Hamilton, Cottesloe (AU)

(21) Appl. No.: 18/036,879

(22) PCT Filed: Nov. 18, 2021
(86) PCT No.: PCT/US2021/059874

§ 371 Date: May 13, 2023

Related U.S. Application Data
(60) Provisional application No. 63/115,480, filed on Nov. 18, 2020.

(51) Int. Cl. B02C 25/00; B02C 17/18

(52) U.S. Cl. CPC B02C 25/00; B02C 17/1805; B02C 2210/01

(57) ABSTRACT

A comminution mill sensor system and methods for monitoring comminution mill operation conditions. The comminution mill sensor system can include a plurality of shell sensor assemblies that are coupled to a comminution mill grinding compartment. The method can include receiving sensing data from a plurality of shell sensor assemblies and determining a two-dimensional process map, a three-dimensional process map, or both, based on the sensing data.

### FIELD OF THE INVENTION

The present disclosure generally relates to detection systems and, more particularly, to detection systems for detecting and monitoring comminution mill operation conditions.

### BACKGROUND OF THE INVENTION

For the extraction or dressing of mineral material from ore, freshly supplied ore material is typically prepared in several process stages, the first of which is the preparation process including a suitable comminution of the fresh ore material supplied from a mine. This comminution, or mechanical pulverization, of the ore material enables the valuable mineral material (typically a mineral ore in the case of most mining operations) to be separated and segregated from waste material. The comminution process typically commences at the point of extraction of the ore material from a mine or surface digging, but then typically involves a crushing stage followed by a grinding stage to achieve a fine material size suitable for the mineral extraction process. Depending on the properties of the ore, as well as the grinding technique, that is used, the mineral material can be crushed to a maximum lump size varying between about 500-100 millimeters (mm).

### SUMMARY OF THE INVENTION

In one aspect, a comminution mill sensor system is provided. The comminution mill sensor system can include a plurality of shell sensor assemblies. Each of the plurality of shell sensor assemblies can include: at least one sensor or sensor array, at least one energy source, and at least one antenna. Each of the plurality of shell sensor assemblies is coupled to a comminution mill grinding compartment. The plurality of shell sensor assemblies are adapted to provide for a plurality of mill interior measurement zones within the comminution mill grinding compartment.

In another aspect, a method for monitoring comminution operation conditions is provided. The method can include receiving sensing data from a plurality of shell sensor assemblies during operation of a comminution mill. Each of the plurality of shell sensor assemblies can include at least one sensor or sensor array, at least one energy source, and at least one antenna. Each of the plurality of shell sensor assemblies can be coupled to a comminution mill grinding compartment of the comminution mill, at spaced apart positions so as to provide a plurality of mill interior measurement zones. The method can also include determining a two-dimensional process map, a three-dimensional process map, or both, based on the sensing data.

### BRIEF DESCRIPTION OF THE DRAWING

Illustrative aspects of the present invention are described in detail below with reference to the attached drawing figures, which are incorporated by reference herein and wherein:

FIG. 1 depicts a comminution mill sensor system, in accordance with aspects of the invention;

FIG. 2A depicts a shell sensor assembly coupled to a liner bolt in an interior portion of a comminution mill grinding compartment, in accordance with aspects of the invention;

FIG. 2B depicts another shell sensor assembly coupled to an exterior portion of a comminution mill grinding compartment; in accordance with aspects of the invention;

FIG. 2C depicts a shell sensor assembly; in accordance with aspects of the invention;

FIG. 2D depicts another shell sensor assembly coupled to a liner bolt in an interior portion of a comminution mill grinding compartment with a channel extending from the shell sensor assembly along the liner bolt and through the shell liner and shell, in accordance with aspects of the invention;

FIG. 2E depicts another shell sensor assembly coupled to an exterior portion of a comminution mill grinding compartment with a channel extending from the shell sensor assembly and through the shell and shell liner; in accordance with aspects of the invention;

FIG. 2F depicts another shell sensor assembly where a first portion of the shell sensor assembly is coupled to an exterior portion of a comminution mill grinding compartment, and a second portion is coupled to an interior portion of the comminution mill grinding compartment with a channel extending between the first and second portions of the shell sensor assembly; in accordance with aspects of the invention;

FIG. 2G depicts another shell sensor assembly where a first portion of the shell sensor assembly is coupled to an exterior portion of a comminution mill grinding compartment, and a second portion is coupled to an interior portion of the comminution mill grinding compartment; in accordance with aspects of the invention;

FIG. 2H depicts another shell sensor assembly coupled to an interior portion of a comminution mill grinding compartment; in accordance with aspects of the invention;

FIG. 2I depicts another shell sensor assembly coupled to an interior portion of a comminution mill grinding compartment with a channel extending from the shell sensor assembly and through the shell liner and shell; in accordance with aspects of the invention;

FIG. 3A depicts a sensor component, in accordance with aspects of the invention;

FIG. 3B depicts a mill charge media sensor element with a sensor component positioned therein, in accordance with aspects of the invention;

FIG. 3C depicts another mill charge media sensor element with a sensor component positioned therein, in accordance with aspects of the invention;

FIG. 4A depicts another comminution mill sensor system, particularly showing a plurality of mill interior measurement zones, in accordance with aspects of the invention;

FIG. 4B depicts a cross section of a comminution mill sensor system showing a plurality of mill interior measurement zones, in accordance with aspects of the invention;

FIGS. 5A-5D depict interval-related collection and/or receipt of sensed data for one or more shell sensor assemblies on a cross section of a comminution mill, in accordance with aspects of the invention;

FIG. 6 depicts a cross section of a comminution mill overlaid with interpreted charge motion and showing various mill charge features or properties, in accordance with aspects of the invention;

FIG. 7 depicts a diagram of an exemplary computing environment suitable for use in implementations of the present disclosure, in accordance with aspects of the invention;

FIG. 8 is a flow diagram of an exemplary method for monitoring comminution mill operation conditions, in accordance with aspects of the invention; and

FIG. 9 depicts a cross section of a comminution mill depicting the mill charge and pool and showing various mill charge features or properties, in accordance with aspects of the invention.

### DETAILED DESCRIPTION OF THE INVENTION

The subject matter of aspects of the present invention is described with specificity herein to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

In this specification where a document, act, or item of knowledge is referred to or discussed, this reference or discussion is not an admission that the document, act, or item of knowledge or any combination thereof was at the priority date, publicly available, known to the public, part of the common general knowledge; or known to be relevant to an attempt to solve any problem with which this specification is concerned.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Representative aspects of the present disclosure relate, generally, to various apparatus, methods, and systems of detecting a mill charge during comminution and/or for monitoring comminution mill operations. In the same or alternative aspects, the systems and methods disclosed herein are related to systems and methods for modelling a mill charge during comminution. The disclosure has particular, but not necessarily exclusive, application to detecting and/or modelling a mill charge during comminution of ore material in a mining and/or mineral processing context. However, it should be understood that the disclosure is not limited to these representative aspects, and may be implemented in other environments using a comminution mill apparatus

There are a number of known methods and apparatuses for the grinding comminution of ore. Certain conventional methods and apparatus involve the use of horizontal grinding mills and include: autogenous (in which grinding is done by utilizing grinding bodies from the ore material itself); semi-autogenous (in which grinding is done in part by the ore material itself, and in part by grinding media (typically, steel balls) which are partially substituted for the ore material in small quantities); and conventional (in which grinding is done exclusively by steel rods within the mill and grinding media (typically, steel balls)).

Within the mineral processing industry, the comminution of an ore material, with the aid of autogenous grinding techniques, generally takes place in three primary ways. Firstly, by impact, being the shock of the ore material falling onto a substructure or against the material itself. Secondly, by attrition, being the most common in rod and ball mills (e.g. conventional and semi-autogenous mills) and in autogenous mills (under favorable conditions). Attrition refers to the process of smaller ore pieces being comminuted by pressure and shearing between larger ore pieces and/or between surfaces under pressure. Thirdly, by abrasion, wherein comminution occurs as a result of the surfaces of pieces of ore material being rubbed/worn against each other. This type of comminution typically requires a large amount of energy and often results in an inconsistently ground ore product.

The comminution technique adopted by a particular mining or mineral processing operation is highly dependent on the ore material being mined, its comminution properties, and/or its ‘grinding resistance’. Ore materials are typically classified according to certain competence ranges that guide the selection of the comminution technique. The first is ‘competent’, referring to ore materials having sufficient mechanical strength to form an active grinding charge in their own right, making them well-suited to autogenous grinding techniques. The second is ‘incompetent’, referring to ore materials requiring the addition of foreign grinding media (e.g., steel balls) to enable their comminution, making them well-suited to semi-autogenous or conventional grinding techniques. The third is ‘over-competent’, referring to ore materials which have very high mechanical strength where their comminution in an autogenous grinding process requires very high energy input, making them more suited to conventional or semi-autogenous grinding techniques.

Historically, the conventional grinding technique (involving the exclusive use of steel rods and balls for grinding) has been used most extensively in the mining industry, and is typically preceded by extensive crushing of the mineral material or ore before grinding as it produces a more stable grinding process, due to the grinding charge being homogeneous in weight and composition. However, this conventional technique is also the most expensive of the grinding techniques mentioned, in terms of both the initial capital investment and ongoing operational expenses.

In accordance with the autogenous technique, a certain proportion of the comminuted material can optionally be recirculated in the mill. Alternatively, certain configurations may include at least one drum mill or agitator mill (arranged after an autogenous mill) in which the comminuted product obtained in the autogenous mill is then reground to the desired fineness of the finished product. These mills can also be interconnected with a classifier so that the ore material is comminuted in a closed circuit and sufficiently fine material is drawn off from the classifier as finished material. An autogenous mill is a type of drum mill of relatively large diameter in which the ore material itself forms the grinding elements. However, such autogenous mills can also include a limited proportion of additional grinding media (such as, for example, steel grinding balls) to assist with the comminution process. This latter type of comminution operation is commonly referred to as a semi-autogenous or SAG mill.

Often with the use of comminution techniques that involve conventional or semi-autogenous grinding (especially drum mills that incorporate steel rods and steel balls as grinding media), it is desirable to observe, monitor and optimize the operating characteristics of the grinding media within the drum. However, due to the harsh nature of the internal environment within the drum (during operation), it is typically not feasible to use sensor or camera/vision systems as the rotational movement of the ore material and grinding media within the drum will likely damage and destroy these systems within a short period of time.

The ability to maintain a constant total load volume in a mill (e.g. SAG mill) at the required feed rate can be an important control requirement. For this reason, certain conventional systems can use loads cells and or acoustic sensors to provide an indication of changes in load level in the mill. However, SAG mills are difficult to operate on power alone, as the power to mill load relationship is not consistent. The power draw to mill load relationship can be affected by changes in the milling density as a result of changes in viscosity and charge fluidity. Furthermore, slurry transfer through and out of the mill affects the size of the slurry pool within the mill and the size of the slurry pool affects power draw. Therefore, changes in circulating load on a single stage mill may affect the size of the slurry pool and consequently the power draw.

Therefore there is a need for a system that can monitor and/or model the comminution process and/or a mill charge during a comminution operation.

As discussed above, at a high level, the systems and method disclosed herein include detection systems for detecting and/or modelling mill charge behavior during comminution, as well as monitoring comminution mill operation conditions. In various aspects, the systems and method disclosed herein can include a plurality of shell sensor assemblies that are coupled to the comminution mill grinding compartment and that can provide detection and information related to a mill charge during comminution. In aspects, this information can be transmitted outside of the comminution mill grinding compartment and can be utilized to provide two- and/or three-dimensional process maps or models of the mill charge during comminution. In various aspects, the systems and methods disclosed herein can provide for real-time monitoring and/or detection of a mill charge and/or comminution operation conditions which can lead to improved operation of the mill charge.

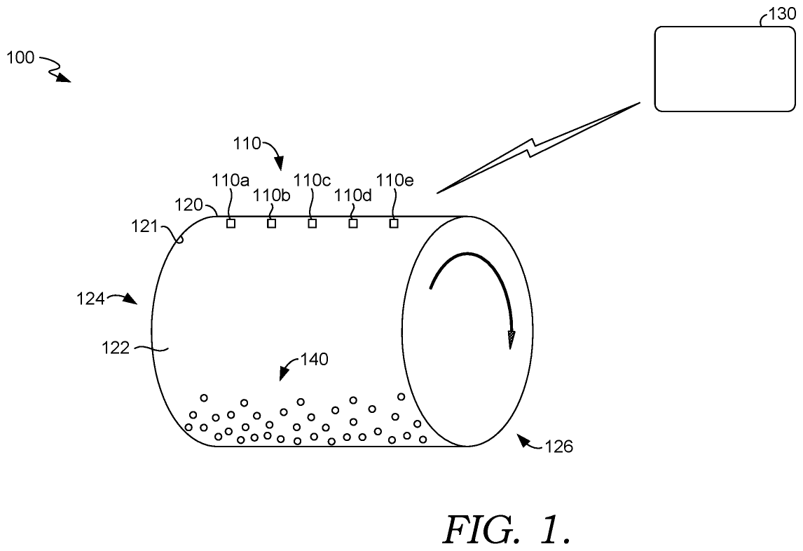

FIG. 1 depicts one example comminution mill sensor system 100. It should be understood that the comminution mill sensor system 100 depicted in FIG. 1 is just one example system and the components therein are depicted schematically to highlight various features. The comminution mill sensor system 100 of FIG. 1 includes a plurality of shell sensor assemblies 110 coupled to an interior portion 121 of a comminution mill 120, e.g., an interior portion 121 of a comminution mill grinding compartment. In the aspect depicted in FIG. 1, each of the plurality of shell sensor assemblies 110 can communicate information from the interior portion 121 of the comminution mill 120 to a receiver 130. As will be discussed further below, such information communicated by the plurality of shell sensor assemblies 110 can include information associated with a mill charge in the interior portion 121 of the comminution mill 120 and/or information associated with comminution mill grinding compartment process conditions. It should be understood that, while in FIG. 1, the shell sensor assemblies 110 are depicted as being coupled to an interior portion 121 of the comminution mill grinding compartment, such an arrangement is just one example position for the shell sensor assemblies and that other positions of the shell sensor assemblies are also contemplated by the systems and methods disclosed herein. For instance, as discussed below, the shell sensor assemblies can be coupled to an interior portion of the comminution mill grinding compartment and/or to an exterior portion of the comminution mill grinding compartment.

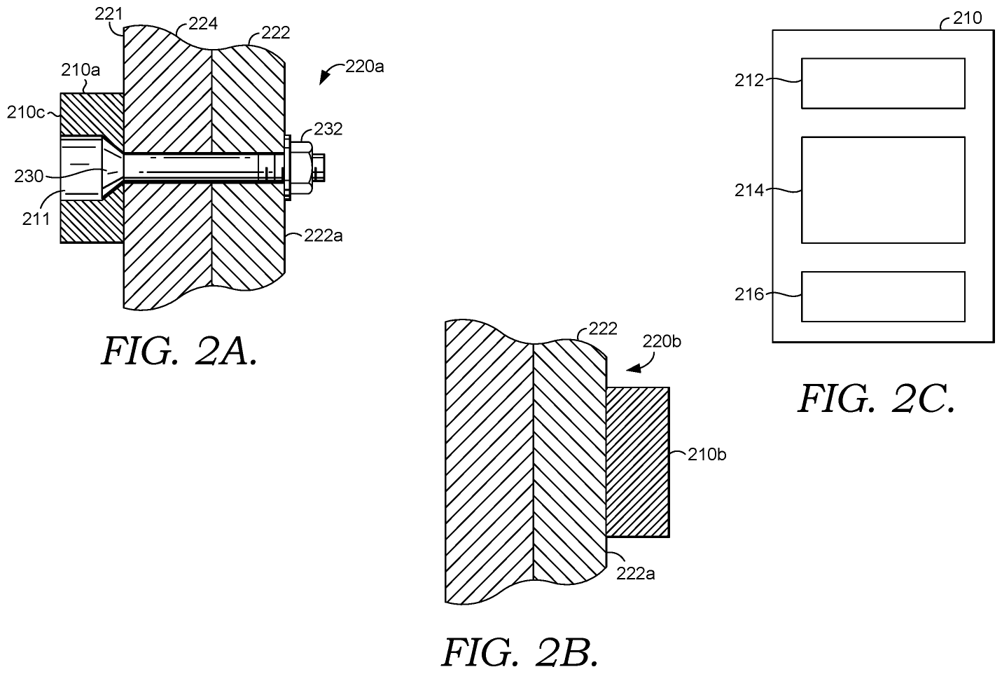

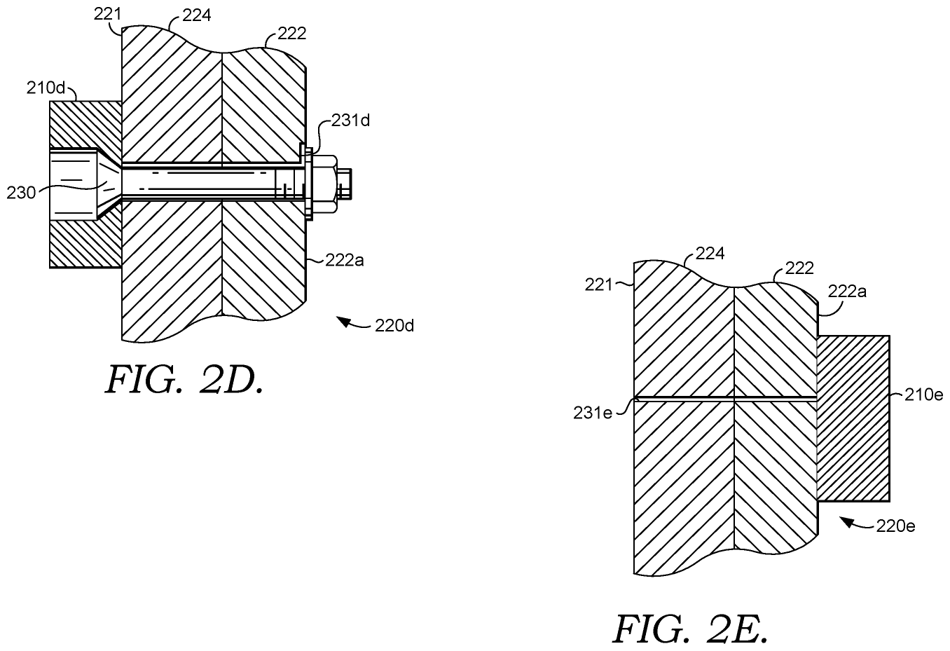

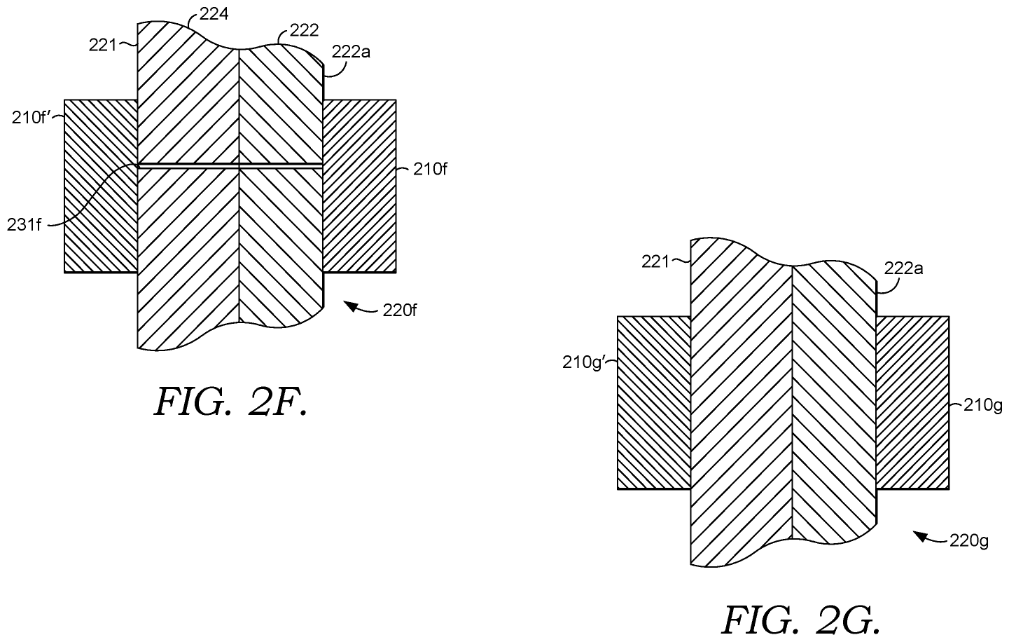

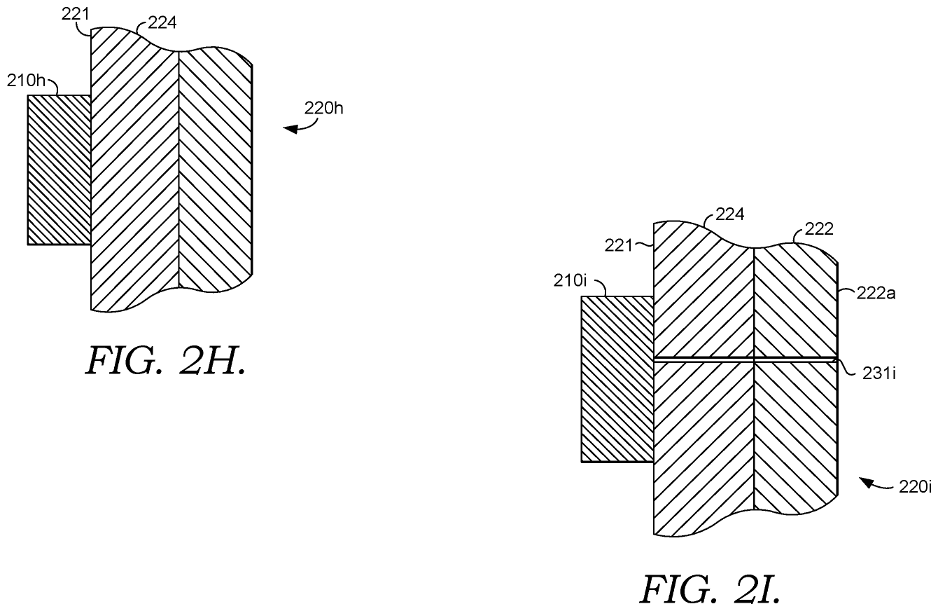

In aspects, the comminution mill 120 depicted in FIG. 1 can be any type of mill used for comminution of a material, e.g., ore. The comminution mill 120 can include a shell 122 that rotates to provide a tumbling motion of the contents, e.g., a mill charge, in the interior portion 121. As will be discussed further below with reference to FIGS. 2A and 2B, the comminution mill 120 can optionally include a shell liner covering at least a portion of the interior portion 121.

In the aspect depicted in FIG. 1, the plurality of shell sensor assemblies 110 are spaced apart within the comminution mill 120. For instance, the shell sensor assemblies 110a, 110b, 110c, 110d, and 110e are all positioned apart from one another in the interior portion 121 of the comminution mill 120. In aspects, the each of the plurality of shell sensor assemblies 110 can be spaced apart from one another by any distance chosen for a particular purpose. In one aspect, the plurality of shell sensor assemblies 110 can be spaced apart to provide for a plurality of mill interior measurement zones within the comminution mill 120. For instance, in the aspect depicted in FIG. 1, the plurality of shell sensor assemblies 110 are axially spaced apart along the interior portion 121 between a feed end 124 and a discharge end 126, which can provide measurement zones for detection of information associated with a mill charge or other feature of the comminution mill 120 in operation. Mill interior measurement zones are discussed in detail further below.

As discussed above, in aspects, the plurality of shell sensor assemblies 110 are operable to communicate sensor data to the receiver 130 that is positioned outside of the comminution mill 120. In the same or alternative aspects, the plurality of shell sensor assemblies 110 can wirelessly communicate sensor data to the receiver 130, e.g., using any convenient wireless communication technology.

In various aspects, the plurality of shell sensor assemblies 110 can be capable of detecting various types of information associated with the mill charge and/or the operation of the comminution mill. The shell sensor assemblies and specific components are discussed in detail further below. The information detected and/or sensed by the plurality of shell sensor assemblies 110 and communicated to the receiver 130 allows for the receiver 130 to provide modelling and/or process maps of the mill charge during comminution mill operation. As discussed further below, this modelling and/or process mapping of the mill charge during comminution can allow for improved comminution mill operation.

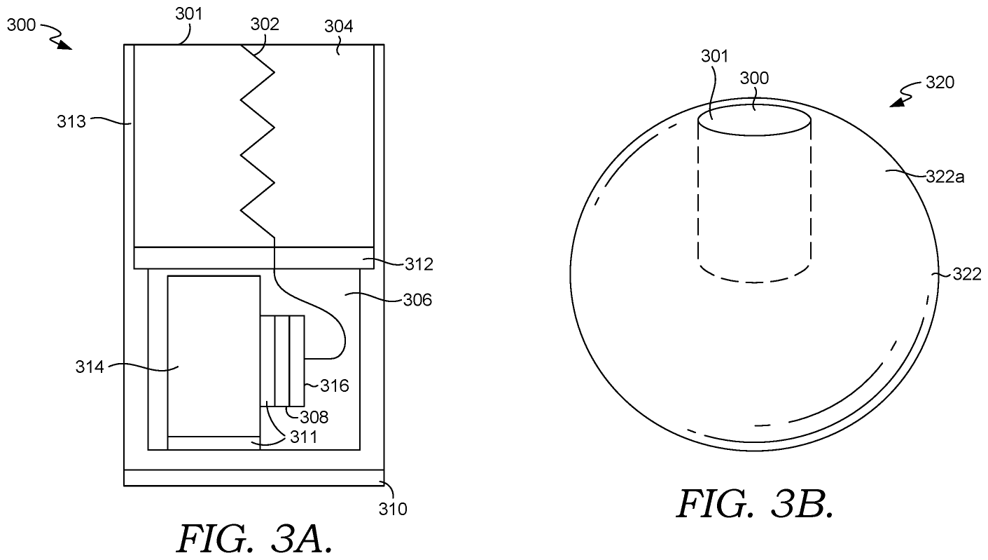

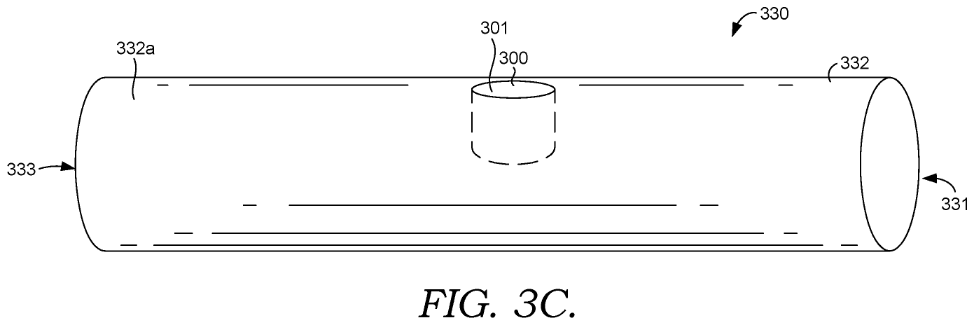

While the plurality of shell sensor assemblies 110 can provide detailed information associated with the mill charge and/or operation of the comminution mill, a plurality of mill charge media sensor elements 140 can optionally be included in the comminution mill sensor system 100, in aspects. The specific features of the mill charge media sensor elements 140 are discussed in detail further below primarily with reference to FIGS. 3A-3C.

In aspects, the mill charge media sensor elements 140 can be freely moving just like the mill charge in the comminution mill, and can sense and/or detect information on the mill charge as well as operating conditions within the comminution mill 120. In aspects, the mill charge media sensor elements 140 can communicate data obtained from onboard sensors to one or more of the shell sensor assemblies 110, which can then in turn communicate this information to the receiver 130. In such aspects, the receiver 130 can utilize the information from both the mill charge media sensor elements 140 and the shell sensor assemblies 110 to provide modelling and/or process maps of the mill charge during comminution mill operation.

FIGS. 2A-2I depict various example aspects of shell sensor assemblies in accordance with the methods and systems disclosed herein. FIG. 2A depicts a cross-sectional view of a portion of a comminution mill 220a with a shell sensor assembly 210a coupled to an inner surface 221 of the comminution mill 220a, e.g., an interior portion of the comminution mill grinding compartment. It should be understood that the shell sensor assembly 210a is schematically depicted to highlight various features described herein.

In the aspect depicted in FIG. 2A, the comminution mill 220a includes a shell 222 and a shell liner 224. In aspects, the shell liner 224 is intended to be a sacrificial wear member. The purpose of this shell liner 224 is to absorb impact of the ore material and grinding media during operation and to minimize damage to (and/or wearing of) the shell 222, in aspects. In such aspects, the use of a shell liner 224 can prolong the effective life of the shell 222/drum and/or the need for costly and extensive machine downtime (e.g., for replacement or repair of the entire shell 222/drum) can be minimized. In certain aspects, the shell liner 224 is can be held in place on an internal surface of the shell/drum by one or more liner bolts that extend through the surface of the shell/drum and are fixed in place by fasteners (e.g. nuts) on the external surface of the shell/drum.

In the aspect depicted in FIG. 2A, the shell sensor assembly 210a is coupled to the inner surface 221 via a liner bolt 230. As discussed above, in aspects, liner bolts, e.g., the liner bolt 230, can secure the shell liner 224 to the shell 222. In the aspect depicted in FIG. 2A, the liner bolt 230 can be coupled to the shell sensor assembly 210a in any suitable manner, e.g., the liner bolt 230 can extend through an aperture 211 and/or engage a flange or other portion of the shell sensor assembly 210a and extend through the shell liner 224 and the shell 222 past an exterior surface 222a of the shell liner 224, where the liner bolt 230 is secured thereto via a fastener 232. In one aspect not depicted in the figures, the aperture 211 may be covered with and/or filled in, e.g., with one or more polymeric or resin materials, to the outer surface 210c. In alternative aspects not depicted in the figures, the aperture 211 can be internal to the shell sensor assembly 210a, e.g., the aperture 211 through which the liner bolt 230 may not extend to the outer surface 210c. In such an aspect, the liner bolt 230 may secure a first portion of the shell sensor assembly 210a to the shell liner 224 and/or the shell 222 and a second portion of the shell sensor assembly 210a may be secured to the first portion of the shell sensor assembly 210a, where this second portion exhibits a uniform or substantially uniform outer surface 210c.

In certain aspects, a shell sensor assembly can be coupled to the comminution mill and/or comminution mill grinding compartment in other positions and/or in other manners not requiring a liner bolt. For instance, FIG. 2B depicts an aspect where the shell sensor assembly 210b is coupled, in the absence of a liner bolt, to the exterior surface 222a of a portion of the comminution mill 220b, e.g. an exterior portion of a comminution mill grinding compartment. In such aspects, the shell sensor assembly 210b can be fixedly, or removably, coupled to the exterior surface 222a using any coupling mechanisms suitable for use on the shell of a comminution mill grinding compartment. For instance, in one or more aspects, the shell sensor assembly 210b can be coupled to the exterior surface 222a using an adhesive material. In the same or alternative aspects, the shell sensor assembly 210b can be coupled or secured to the exterior surface 222a using mechanical fasteners, e.g., bolts, screws, and the like, which may extend into the shell 222. In various aspects, the shell sensor assembly 210b can be coupled to the exterior surface 222a using a magnet, e.g., a magnet positioned on the exterior surface 222a of the comminution mill 220b.

FIG. 2C depicts a schematic representation of a shell sensor assembly 210. The shell sensor assembly 210 of FIG. 2C can include one or more sensors 212, one or more antennas 214, and an energy source 216. In aspects, the one or more sensors 212 can be any suitable sensor or sensor array for use in a comminution mill. In aspects, the one or more sensors 212 can include: at least one Radio frequency Identification (RFID) sensor and/or transmitter, at least one inertial measurement unit (IMU), where the IMU comprises an accelerometer sensor and/or a gyroscope sensor, at least one magnetic sensor, at least one absolute position sensor, at least one angular speed sensor, at least one impact sensor, or any combination thereof. In certain aspects, the at least one magnetic sensor can include one or more of a magnetometer, a hall effect sensor, or a reed switch. In aspects, the one or more sensors 212 can be adapted to sense impact data, absolute position, absolute position of impact data, or a combination thereof. In aspects, the one or more antennas 214 can be coupled to the one or more sensors 212 for communicating the sensed data and/or process data from the shell sensor assembly 210, e.g., to a receiver 130. In an aspect not depicted in FIG. 2C, the shell sensor assembly 210 can include a printed circuit board through which the sensors 212, antenna 214, and/or energy source 216 are coupled. In the same or alternative aspects, the shell sensor assembly 210 can include a processor and/or transmitting component for transmitting the sensed data and/or process data from the shell sensor assembly 210 via the antenna 214. In various aspects, the energy source 216 can be any suitable energy source for providing power to the one or more sensors 212 and/or the one or more antennas 214 or associated components.

In certain scenarios, transmitting data from within certain metal environments to an external receiver may be difficult due to a dampening or inability for electromagnetic radiation to escape certain metal structures, if present. In various aspects, the systems and methods disclosed herein can provide consistent communication of sensed data and/or process data from within a comminution grinding compartment to an outside or external receiver. For example, in certain aspects, at least a portion of an antenna of the shell sensor assembly may extend from the comminution compartment past the mill shell and/or to the mill shell for transmitting the process data and/or sensed data.

As depicted in FIG. 2D, the shell sensor assembly 210d is coupled to the inner surface 221 of the comminution mill 220d via a liner bolt 230, as described above with reference to FIG. 2A. In FIG. 2D, a channel 231d is present which extends from the shell sensor assembly 210d through the shell liner 224, and the shell 222, to the exterior surface 222a of the shell 222. The channel 231d can be created in any suitable manner. In one aspect, the channel 231d can be formed from the use of a liner bolt 230 that does not seal off or extend the entirety of the diameter of an aperture through which the liner bolt 230 extends. In various aspects, an antenna, e.g., the antenna 214 of the shell sensor assembly 210, can extend to the exterior surface 222a of the shell 222 to provide improved communication to the receiver, e.g., the receiver 130.

FIG. 2E depicts the shell sensor assembly 210e coupled to the exterior surface 222a of the comminution mill 220e in the absence of a liner bolt, as described above with reference to FIG. 2B. In FIG. 2E, a channel 231e is present which extends from the shell sensor assembly 210e through the shell 222, and the shell liner 224, to the inner surface 221 of the shell liner 224. The channel 231e can be created in any suitable manner. In various aspects, an antenna, e.g., the antenna 214 of the shell sensor assembly 210, can extend to the inner surface 221 of the shell liner 224 to provide improved communication, e.g., to the mill charge media sensor elements in the comminution mill grinding compartment.

In certain aspects, the shell sensor assemblies can be positioned in an interior portion of the comminution mill, e.g., an interior portion of a comminution mill grinding compartment. For instance, in FIG. 2H, the shell sensor assembly 210h is coupled an inner surface 221 of the shell liner 224 of the comminution mill 220h. In such aspects, the shell sensor assembly 210h can be fixedly, or removably, coupled to the inner surface 221 using any coupling mechanisms suitable for use on the shell liner of a comminution mill grinding compartment. For instance, in one or more aspects, the shell sensor assembly 210h can be coupled to the inner surface 221 using an adhesive material. In the same or alternative aspects, the shell sensor assembly 210h can be coupled or secured to the inner surface 221 using mechanical fasteners, e.g., bolts, screws, and the like, which may extend into the shell liner 224. In various aspects, the shell sensor assembly 210h can be coupled to the inner surface 221 using a magnet, e.g., a magnet positioned on the inner surface 221 of the comminution mill 220h.

FIG. 2I depicts another shell sensor assembly 210i coupled to an interior portion of the comminution mill 220i, e.g., an interior portion of the comminution mill grinding compartment. For instance, the shell sensor assembly 210i is coupled to an inner surface 221 of the comminution mill 220i. In the aspect depicted in FIG. 2I, a channel 231i is present, which extends from the shell sensor assembly 210i through the shell liner 224, and the shell 222, to the exterior surface 222a of the shell 222. The channel 231i can be created in any suitable manner, such as the manners discussed above. In various aspects, an antenna, e.g., the antenna 214 of the shell sensor assembly 210, can extend to the exterior surface 222a of the shell 222 to provide improved communication to the receiver, e.g., the receiver 130.

In various aspects, individual shell sensor assemblies can be coupled both to an interior portion of a comminution mill grinding compartment and to an exterior portion of a comminution mill grinding compartment. For instance, in the aspect depicted in FIG. 2F a first portion of the shell sensor assembly 210f is coupled to an exterior surface 222a of the comminution mill 220f, while a second portion of the shell sensor assembly 210f′ is coupled to an inner surface 221 of the comminution mill 220f. In the aspect depicted in FIG. 2F, a channel 231f can extend from the first portion of the shell sensor assembly 210f, through the shell 222 and shell liner 224 to the second portion of the shell sensor assembly 210f′. In such aspects, the channel 231f may provide for one or more physical, digital, electric, and/or electromagnetic connections between the first portion of the shell sensor assembly 210f and the second portion of the shell sensor assembly 210f′, e.g., so that both portions can share an energy source, antenna, processor, radio, or other shell sensor components.

FIG. 2G depicts another aspect of a shell sensor assembly coupled to both an interior portion of a comminution mill grinding compartment and to an exterior portion of a comminution mill grinding compartment. As can be seen in the aspect depicted in FIG. 2G, a first portion of the shell sensor assembly 210g is coupled to an exterior surface 222a of the comminution mill 220g, while a second portion of the shell sensor assembly 210g′ is coupled to an inner surface 221 of the comminution mill 220g.

In certain aspects, the systems and methods disclosed herein can optionally include one or more mill charge media sensor elements, such as the mill charge media sensor elements 140 depicted in FIG. 1. As discussed above, the mill charge media sensor elements can be freely moving just like the mill charge in the comminution mill, and can sense and/or detect information on the mill charge as well as operating conditions within the comminution mill grinding compartment, and can communicate data obtained from onboard sensors to one or more of the shell sensor assemblies, which can then, in turn communicate this information to a receiver, e.g., the receiver 130.

In various aspects, the mill charge media sensor elements can comprise and/or be equipped with any number of sensors for detecting one or more events or the environment in the comminution mill grinding compartment, and can be adapted to communicate such information to one or more shell sensor assemblies. In certain aspects, the mill charge media sensor elements can communicate or transmit, e.g., to one or more shell sensor assemblies, information associated with RFID data, accelerometer G-Force data, accelerometer spin data, temperature data, or a combination thereof. At a high level, the mill charge media sensor elements can include a sensor component and a housing. FIGS. 3B and 3C depict two example mill charge media sensor elements, and FIG. 3A depicts an example sensor component.

FIG. 3A depicts one example sensor component 300 that can be utilized in the mill charge media sensor elements disclosed herein. In certain aspects, the sensor component 300 can be an impact-resistant sensor component. In the same or alternative aspects, the sensor component 300 can maintain functionality (e.g., function as a sensor and/or detector and be capable of transmitting sensed data) under average g-forces of up to about 16 g. In aspects, the sensor component 300 can include one or more sensors, one or more energy sources, one or more antennas, an RFID sensor and/or RFID transmitter. As can be seen in the aspect depicted in FIG. 3A, the sensor component 300 includes a battery 314, one or more sensors 308, the printed circuit board 316 and an antenna 302 coupled thereto, which can be housed in an outer casing 313. The outer casing 313 can be formed from any type of material suitable for use in the sensor component 300 and/or the methods and systems disclosed herein. In one or more aspects the outer casing 313 can include a polymeric material, such as for example, a polycarbonate material. Optional additional insulating or cushioning components and/or structural components of the sensor component 300 are discussed further below.

The battery 314 can be any type of battery that is suitable for use in the sensor component 300 and/or in the systems and methods disclosed herein. In various aspects, the battery 314 can include a lithium cell battery, e.g., a lithium cell coin battery or the like. A cushioning element 311 can be positioned around the battery 314 and/or adjacent the one or more sensors 308. In various aspects, the cushioning element 311 can be any suitable cushioning material, such as, for example, a polymeric foam composition and/or a low-density polymeric foam composition.

In various aspects, the one or more sensors 308 can include a temperature sensor, an accelerometer sensor, a gyroscope, a magnetic sensor, a gyroscope, a capacitive sensor, a microphone, an RFID sensor, any other sensor that can measure rotation or spin, or a combination thereof. Any types of specific sensors can be included that are suitable for use in the sensor component 300 and/or in the systems and methods disclosed herein. In various aspects, the one or more sensors 308 can be coupled to a printed circuit board along with one or more processors.

In various aspects, the antenna 302 can include a metal material. In one aspect, the antenna 302 can include a copper beryllium alloy. In certain aspects, at least a portion of the antenna 302 can form a helical structure.

In various aspects, the sensor component 300 can include a bottom cushioning material 310, e.g., a silicone material. In the same or alternative aspects, a potting material 306 can be present that fills in around one or more of the sensors 308 and/or the printed circuit board 316 and/or the battery 314. The potting material 306 can include any polymeric material, such as, for example, a silicone, polyurethane, resin, epoxy, or other elastomeric material. A similar or different potting material 304 can be used to fill in around the antenna 302.

In certain aspects, optionally, a disc or ring 312, which can comprise a metal, such as steel, can be positioned inside the sensor component 300 to create a bottom chamber comprising the battery 314, the one or more sensors 308 and the printed circuit board 316; and a top chamber comprising the antenna 302. In the aspect depicted in FIG. 3A, the printed circuit board 316 connects the antenna 302, the sensors 308, and the battery 314. In various aspects, the antenna 302 can extend to the top surface 301 of the sensor component 300.

In various aspects, not depicted in FIG. 3A, the sensor component 300 and/or a mill charge media sensor element can include an RFID tag or other identification information that can be detected and/or received by one or more shell sensor assemblies.

As discussed above, in aspects, the mill charge media sensor elements and/or the sensor component 300 can communicate data obtained from onboard sensors to one or more of the shell sensor assemblies, which can then, in turn, communicate this information to a receiver, e.g., the receiver 130. The mill charge media sensor element and/or the sensor component 300 can relay the sensed data to the shell sensor assembly using any convenient wireless communication technology, including but not limited to WiFi, Near-field communication (NFC), Bluetooth, and the like.

As can be seen in FIG. 3B, the mill charge media sensor element 320 includes a housing 322 and a sensor component 300. As can be seen in FIG. 3B, the sensor component 300 is positioned inside of the housing 322, e.g., in a recess, with a top surface 301 substantially aligned with the outer surface 322a of the housing 322. In the aspect depicted in FIG. 3B, the housing 322 and/or the mill charge media sensor element 320 is generally spherically shaped. The housing 322 can be any type of suitable material able to withstand the environment inside of a comminution mill grinding compartment during operation and/or that can provide protection to the sensor component 300 during operation of the comminution mill. In aspects, the housing 322 can include a metal material, a polymeric material, or a combination thereof. In one aspect, the housing 322 can be a form of grinding media, e.g., a grinding ball used in a comminution process. In an alternative aspect, the housing 322 can be a polymeric material. In certain aspects, the housing can primarily be formed from a metal material, and a polymeric material can be positioned over the top surface 301 of the mill charge media sensor element 320. In various aspects, an adhesive or polymeric material can be utilized to secure the sensor component 300 in the housing 322.

In the aspect depicted in FIG. 3C, the mill charge media sensor element 330 includes a housing 332 that is shaped differently than the housing 322 of FIG. 3B. As can be seen in FIG. 3C, the mill charge media sensor element 330 and/or the housing 332 exhibits a rod and/or cylindrical shape. In the aspect depicted in FIG. 3C, the sensor component 300 is positioned inside of the housing 332, e.g., in a recess, with a top surface 301 substantially aligned with the outer surface 332a of the housing 332. In the aspect depicted in FIG. 3C, the sensor component is positioned between the ends 331 and 333 of the mill charge media sensor element 330. In alternative aspects not depicted in the figures, the sensor component 300 can be positioned at or adjacent one of the ends 331 and 333, or anywhere else within the housing 332. The housing 332 can be any type of suitable material able to withstand the environment inside of a comminution mill grinding compartment during operation and/or can provide protection to the sensor component 300 during operation of the comminution mill. In aspects, the housing 332 can include a metal material, a polymeric material, or a combination thereof. In one aspect, the housing 332 can be a form of grinding media, e.g., a grinding rod used in a comminution process. In an alternative aspect, the housing 332 can be a polymeric material. In certain aspects, the housing can primarily be formed from a metal material, and a polymeric material can be positioned over the top surface 301 of the mill charge media sensor element 330. In various aspects, an adhesive or polymeric material can be utilized to secure the sensor component 300 in the housing 332.

It should be understood that the specific shapes and sizes of the housings, and of the shape, position, size, and number of sensor components in the mill charge media sensor elements 320 and 330 of FIGS. 3B and 3C are just two examples and that other housing shapes, sizes, and positioning and/or number of sensor components in the housings is contemplated by the disclosure herein. For instance, in one non-limiting alternative aspect, a mill charge media sensor element may include more than one sensor component.

As discussed above, in certain aspects, the shell sensor assemblies can be spaced apart from one another and can provide a plurality of mill interior measurement zones. In aspects, any number of mill interior measurement zones can be provided. In one aspect, the plurality of mill interior measurement zones can include at least two, at least three, at least four, or at least five mill interior measurement zones.

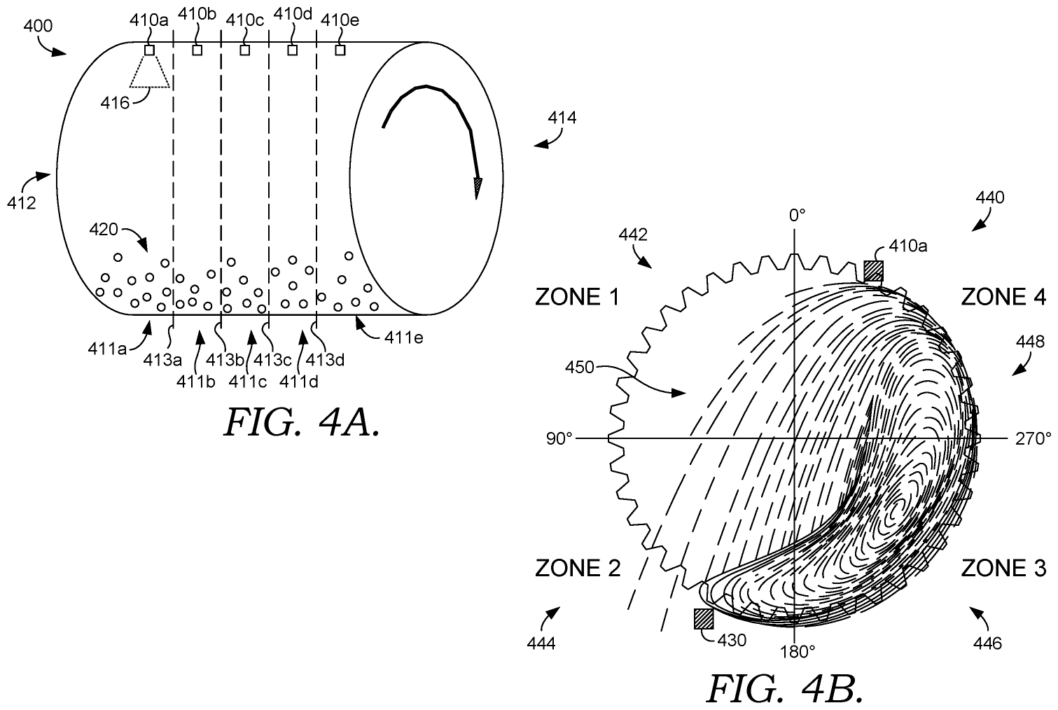

As can be seen in FIG. 4A, a comminution mill 400 includes shell sensor assemblies 410a, 410b, 410c, 410d, and 410e coupled to an interior of the mill and/or to the shell liner in the interior of the mill. It should be understood that, while in FIG. 4, the shell sensor assemblies 410a, 410b, 410c, 410d, and 410e are depicted as being coupled to an interior portion of the comminution mill grinding compartment, such an arrangement is just one example position for the shell sensor assemblies and that other positions of the shell sensor assemblies are also contemplated by the systems and methods disclosed herein. For instance, as discussed below, the shell sensor assemblies can be coupled to an interior portion of the comminution mill grinding compartment and/or to an exterior portion of the comminution mill grinding compartment.

In the aspect depicted in FIG. 4A, the shell sensor assemblies 410a, 410b, 410c, 410d, and 410e are spaced apart from one another and can provide five mill interior measurement zones 411a, 411b, 411c, 411d, and 411e within the comminution mill grinding compartment. In certain aspects, the five mill interior measurement zones 411a, 411b, 411c, 411d, and 411e can comprise a substantially equal arrangement of zones distributed along the length of the comminution mill grinding compartment of the comminution mill 400 and/or along the length of an interior of the comminution mill 400 extending between the feed end 412 and the discharge end 414. It should be understood that while five mill interior measurement zones are depicted in FIG. 4A, other amounts of mill interior measurement zones are also contemplated by the disclosure herein.

In one or more aspects, the mill interior measurement zone 411a can extend from the feed end 412 to, generally, the dashed line 413a. The mill interior measurement zone 411a can include the shell sensor assembly 410a, which can provide sensor measurements for this mill interior measurement zone 411a. In one or more aspects, the mill interior measurement zone 411b can extend between the dashed lines 413a and 413b. The mill interior measurement zone 411b can include the shell sensor assembly 410b, which can provide sensor measurements for this zone. In one or more aspects, the mill interior measurement zone 411c can extend between the dashed lines 413b and 413c. The mill interior measurement zone 411c can include the shell sensor assembly 410c, which can provide sensor measurements for this zone. In one or more aspects, the mill interior measurement zone 411d can extend between the dashed lines 413c and 413d. The mill interior measurement zone 411d can include the shell sensor assembly 410d, which can provide sensor measurements for this zone. In one or more aspects, the mill interior measurement zone 411e can extend between the dashed line 413d to the discharge end 414. The mill interior measurement zone 411e can include the shell sensor assembly 410e, which can provide sensor measurements for this zone. In aspects, the mill interior measurement zones 411a, 411b, 411c, 411d, and 411e can be axial measurement zones, e.g., zones that extend along an axis that extends between the feed end 412 and the discharge end 414 of the comminution mill 400.

In aspects, as discussed above, mill charge media sensor elements can optionally be present in the interior of the mill, e.g., the comminution mill grinding compartment. As also discussed above, in aspects, the mill charge media sensor elements can communicate data obtained from onboard sensors to one or more of the shell sensor assemblies, which can then, in turn, communicate this information to a receiver, e.g., the receiver 130. In aspects, mill charge media sensor elements that are within a zone of detection of an individual shell sensor assembly can relay the sensed data to that shell sensor assembly.

In various aspects, the shell sensor assemblies can be adapted to receive sensed data from a mill charge media sensor element and/or detect the proximate presence of a mill charge media sensor element when the mill charge media sensor element is within about 150 centimeters (cm), within about 100 cm, within about 75 cm, within about 50 cm, or within about 30 cm of the shell sensor assembly and/or of a receiving antenna of the shell sensor assembly. In various aspects, the range with which a shell sensor assembly can receive sensed data from a mill charge media sensor and/or detect the presence of the mill charge media sensor can also be referred to as a zone of detection and/or an axial zone of detection. As can be seen in FIG. 4A, mill charge media sensor elements 420 that are within an axial zone of detection 416 of the shell sensor assembly 410a can relay or transmit mill charge media sensor data to the shell sensor assembly 410a. It should be understood that the depiction of the axial zone of detection 416 is merely a schematic depiction and is not intended to limit the meaning of an axial zone of detection.

It should also be understood that while the comminution mill 400 depicted herein only depicts one shell sensor assembly per mill interior measurement zone, any number of shell sensor assemblies can be present in a mill interior measurement zone. For instance, in an aspect depicted in FIG. 4B, there can be another shell sensor assembly 430 opposite the position of the shell sensor assembly 410a, or about 180° apart.

FIG. 4B depicts one example of mill interior measurement zones in a cross section 440 of a comminution mill. In the cross section 440 of FIG. 4B, a depiction of the trajectory of a mill charge and any mill charge media sensor elements is also provided via the plurality of lines 450. In this cross section 440 the mill or comminution mill grinding compartment is rotating counterclockwise, e.g., from 0° to 90°. The behavior and/or characteristics of the mill charge are described further below.

In the aspect depicted in FIG. 4B, the cross section comprises four radial measurement zones. As can be seen in FIG. 4B, radial measurement zone 1 (442) is positioned between 0° and 90° and, when the mill or comminution mill grinding compartment is rotating in a counterclockwise manner, can be associated with an open portion of the mill charge and/or a dead zone, as discussed further below. As can be seen in FIG. 4B, radial measurement zone 2 (444) is positioned between 90° and 180° and, when the mill or comminution mill grinding compartment is rotating in a counterclockwise manner, can include a toe portion of the mill charge, as discussed further below. The radial measurement zone 3 (446) is positioned between 180° and 270° and, when the mill or comminution mill grinding compartment is rotating in a counterclockwise manner, can include a kidney portion of the mill charge, as discussed further below. The radial measurement zone 4 (448) is positioned between 270° and 0° and, when the mill or comminution mill grinding compartment is rotating in a counterclockwise manner, can include a shoulder portion of the mill charge, as discussed further below.

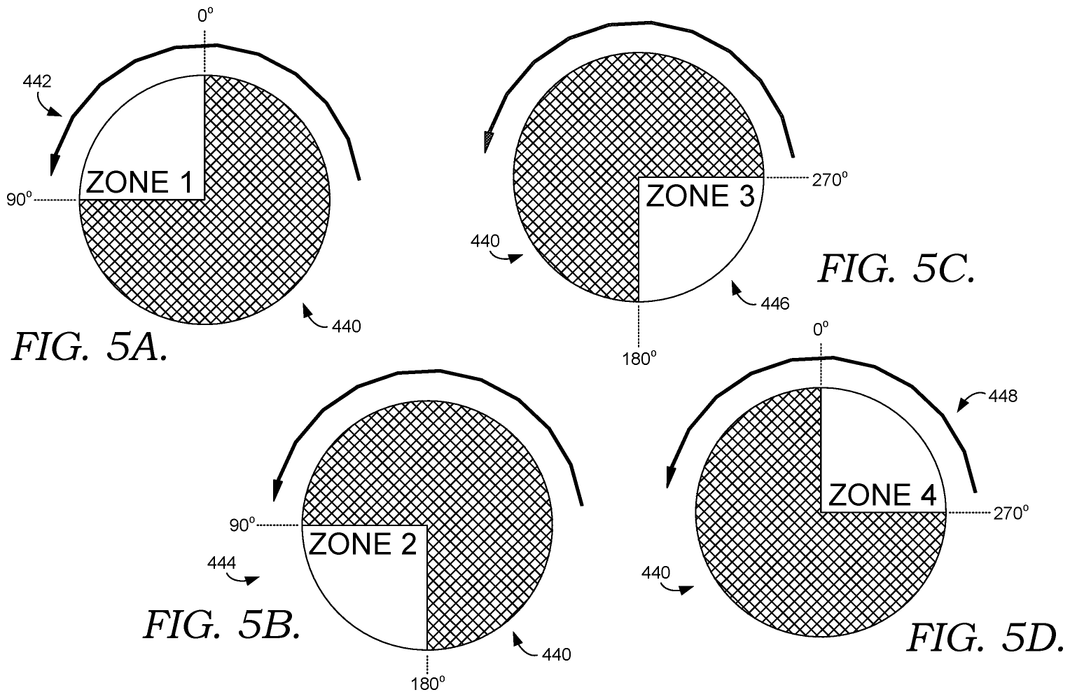

In certain aspects, the shell sensor assemblies can receive data broadcast or transmitted from the mill charge media sensor elements continually or at various intervals. In aspects wherein the shell sensor assemblies receive data broadcast or transmitted from the mill charge media sensor elements at various intervals, the intervals can be process related. For example, in certain aspects, the shell sensor assemblies can receive data broadcast or transmitted from the mill charge media sensor elements based on an absolute and/or specific position of the shell sensor assembly. FIGS. 5A-5D depict one example aspect for an interval-related collection and/or receipt of sensed data, illustrated on a cross section 440 of a comminution mill. In the aspects depicted in FIGS. 5A-5D, the comminution mill rotates in a counterclockwise manner, as depicted by the arrow. In the example aspect of FIG. 5A, as the communication mill and/or comminution mill grinding compartment is rotating and a shell sensor assembly rotates from the 0° position to the 90° position the shell sensor assembly can be configured to receive data broadcast or transmitted by one or more mill charge media sensor elements within a zone of detection, e.g., an axial zone of detection, of the shell sensor assembly. In aspects, the shell sensor assembly can detect its absolute position, e.g., detect that it is rotating from 0° to 90°. In one or more aspects, when the shell sensor assembly reaches the position of 90°, the shell sensor assembly can transmit the received data from the mill charge media sensor elements, and/or the data detected by the shell sensor assembly itself to a receiver. Stated differently, in various aspects, as the shell sensor assembly is at the 0° position it can begin reading shell sensor assembly obtained data and/or receive data from one or more mill charge media sensor elements within a zone of detection, and can continue to read and/or receive such data until the 90° position, at which point the shell sensor assembly transmits this data to the receiver. In such aspects, the transmitted data can be associated with this radial measurement zone 1 (442) of the comminution mill grinding compartment.

In the example aspect of FIG. 5B, as the communication mill and/or comminution compartment is rotating and a shell sensor assembly rotates from the 90° position to the 180° position the shell sensor assembly can be configured to receive data broadcast or transmitted by one or more mill charge media sensor elements within a zone of detection, e.g., an axial zone of detection, of the shell sensor assembly. In aspects, the shell sensor assembly can detect its absolute position, e.g., detect that it is rotating from 90° to 180°. In one or more aspects, when the shell sensor assembly reaches the position of 180°, the shell sensor assembly can transmit the received data from the mill charge media sensor elements, and/or the data detected by the shell sensor assembly itself to a receiver. Stated differently, in various aspects, as the shell sensor assembly is at the 90° position it can begin reading shell sensor assembly obtained data and/or receive data from one or more mill charge media sensor elements within a zone of detection, and can continue to read and/or receive such data until the 180° position, at which point the shell sensor assembly transmits this data to the receiver. In such aspects, the transmitted data can be associated with this zone 2 (444) of the comminution compartment.

In the example aspect of FIG. 5C, as the communication mill and/or comminution compartment is rotating and a shell sensor assembly rotates from the 180° position to the 270° position the shell sensor assembly can be configured to receive data broadcast or transmitted by one or more mill charge media sensor elements within a zone of detection, e.g., an axial zone of detection, of the shell sensor assembly. In aspects, the shell sensor assembly can detect its absolute position, e.g., detect that it is rotating from the 180° position to the 270° position. In one or more aspects, when the shell sensor assembly reaches the position of 270°, the shell sensor assembly can transmit the received data from the mill charge media sensor elements, and/or the data detected by the shell sensor assembly itself to a receiver. Stated differently, in various aspects, as the shell sensor assembly is at the 180° position it can begin reading shell sensor assembly obtained data and/or receive data from one or more mill charge media sensor elements within a zone of detection, and can continue to read and/or receive such data until the 270° position, at which point the shell sensor assembly transmits this data to the receiver. In such aspects, the transmitted data can be associated with this zone 3 (446) of the comminution mill grinding compartment.

In the example aspect of FIG. 5D, as the communication mill and/or comminution compartment is rotating and a shell sensor assembly rotates from the 270° position to the 0° position the shell sensor assembly can be configured to receive data broadcast or transmitted by one or more mill charge media sensor elements within a zone of detection, e.g., an axial zone of detection, of the shell sensor assembly. In aspects, the shell sensor assembly can detect its absolute position, e.g., detect that it is rotating from the 270° position to the 0° position. In one or more aspects, when the shell sensor assembly reaches the position of 0°, the shell sensor assembly can transmit the received data from the mill charge media sensor elements, and/or the data detected by the shell sensor assembly itself to a receiver. Stated differently, in various aspects, as the shell sensor assembly is at the 270° position it can begin reading shell sensor assembly obtained data and/or receive data from one or more mill charge media sensor elements within a zone of detection, and can continue to read and/or receive such data until the 0° position, at which point the shell sensor assembly transmits this data to the receiver. In such aspects, the transmitted data can be associated with this zone 4 (448) of the comminution mill grinding compartment.

It should be understood that while in the example aspects depicted in FIGS. 5A-5D, the process related intervals were associated with 0°, 90°, 180°, and 270°, other comminution mill grinding compartment positions are also contemplated for use herein. For instance, the process related intervals can be associated with any other rotational position of the comminution mill grinding compartment, such as intervals defined by 45°, 135°, 225°, and 315°, or 50°, 120°, 220°, and 300°. In certain aspects, a specific interval parameter can be chosen by one of skill in the art for a particular purpose.

In aspects wherein the shell sensor assemblies receive data broadcast or transmitted from the mill charge media sensor elements at various intervals, the intervals can be time related. In such aspects, the shell sensor assemblies can communicate the sensed data, process data, or both from the shell sensor assemblies, and/or the sensed data, process data, or both received from the mill charge media sensor elements at specific time intervals, such as, for example, every 0.1 seconds, every 0.5 seconds, every second, every 5 seconds, every 10 seconds, every 30 seconds, or every minute.

In certain aspects, as discussed above, the shell sensor assemblies can detect absolute position, e.g., with respect to the rotational position of the comminution mill grinding compartment. In the same or alternative aspects not depicted in the figures, the comminution mill sensor systems disclosed herein can include a calibration reference point, e.g., a magnetic calibration reference point. In such aspects, when a shell sensor assembly passes the calibration reference point, the shell sensor assembly can re-zero or otherwise calibrate the sensor absolute position, e.g., using a magnetic sensor onboard the shell sensor assembly.

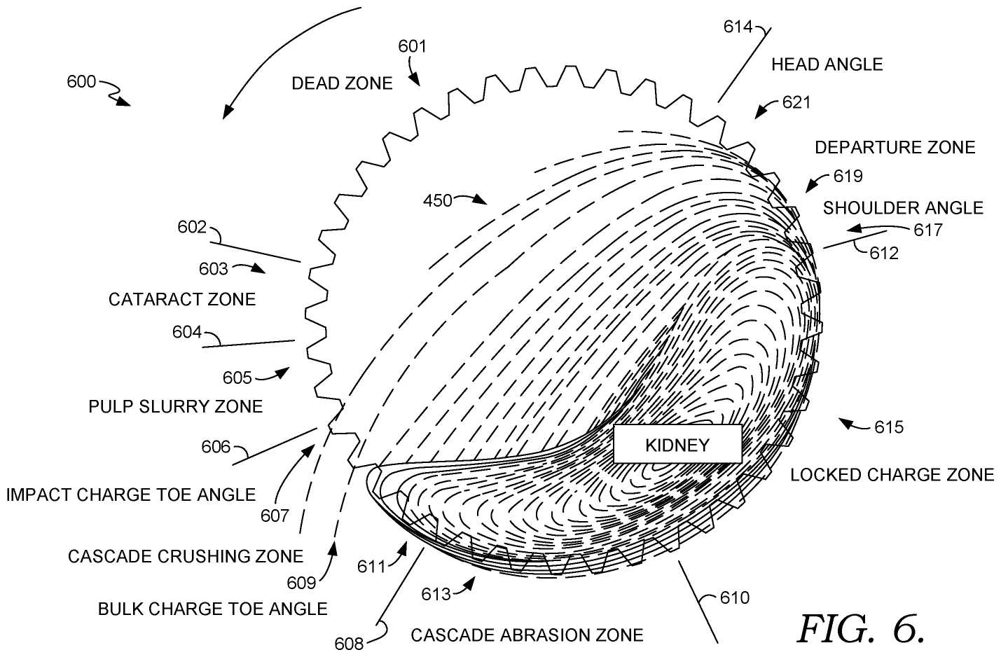

FIG. 6 depicts a cross section 600 of a comminution mill grinding compartment overlaid with interpreted mill charge motion during comminution based on data obtained from one or more of the methods and systems disclosed herein. In FIG. 6, this motion of the mill charge and any mill charge media sensor elements is depicted as the plurality of lines 450.

As can be seen in FIG. 6, a pulp slurry zone 605 is depicted, which is positioned between the reference points 604 and 606. The pulp slurry zone 605 is a zone in which there are typically low or no impacts due to the dampening effect of the pulp density. The pulp slurry zone 605 is typically a liquid phase between the cataract zone 603 and cascade zones, e.g., cascade crushing zone 609 and/or cascade abrasion zone 613. Adjacent to the pulp slurry zone 605 is the cascade crushing zone 609, which is a high impact, high volume, and high velocity region for cascading material (i.e. ore material and/or mill charge media sensor elements). The cascade crushing zone 609 is positioned between the reference points 606 and 608. Additionally, in aspects, the cascade crushing zone 609 defines, at its lower end, an impact charge toe angle 607, and, at its upper end, a bulk charge toe angle 611. Adjacent to the cascade crushing zone 609 is the cascade abrasion zone 613, which is a medium impact region with a significant mass of mill charge material and/or mill charge media sensor elements, wherein comminution typically occurs through rolling and grinding. The cascade abrasion zone 613 is positioned between reference points 608 and 610. Adjacent to the cascade abrasion zone 613 is the locked charge zone 615, which, in aspects, defines the shape of the charge ‘kidney’. The locked charge zone 615 is positioned between the reference points 610 and 612. Within the locked charge zone 615, there is little (to no) relative movement of the grinding charge material (e.g., mill charge material and/or mill charge media sensor elements) against the liner (not shown) of the comminution mill grinding compartment. Adjacent to the locked charge zone 615 is the departure zone 619, which is the region within the grinding charge material (e.g., mill charge material and/or mill charge media sensor elements) that departs from the liner (not shown) of the comminution mill grinding compartment. The departure zone 619 is positioned between the reference points 612 and 614. Additionally, the departure zone 619 defines, at its lower end, a shoulder angle 617, and, at its upper end, a head angle 621. Adjacent the departure zone 619 is the dead zone 601 in which there are typically no impacts of the charge material (e.g., mill charge material and/or mill charge media sensor elements) against the liner (not shown) of the comminution mill grinding compartment. The dead zone 601 is positioned between reference points 614 and 602. Adjacent the dead zone 601, and directly above the pulp slurry zone 605, is the cataract zone 603, which is a low impact, low angle of impact, and low volume region of the comminution mill compartment (in which there is only light cataracting of the grinding charge material (e.g., mill charge material and/or mill charge media sensor elements). The cataract zone 603 is positioned between the reference points 602 and 604.

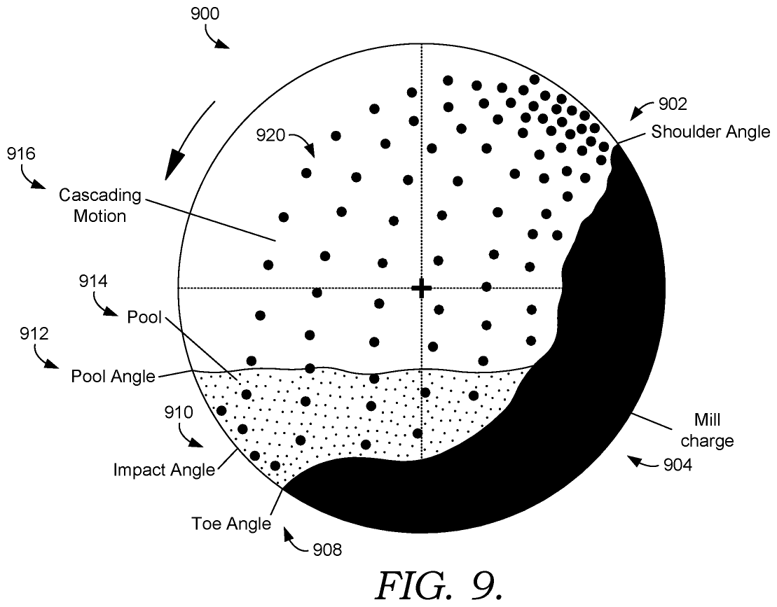

FIG. 9 is another depiction of a cross section 900 of a comminution mill grinding compartment and includes a schematic illustration of the motion and/or position of the mill charge and/or the mill charge media sensor elements. Further, FIG. 9 also includes certain zones mentioned in FIG. 6 to provide additional context to the motion and/or position of the mill charge and/or the mill charge media sensor elements. As can be seen in FIG. 9, the shoulder angle 902 and toe angle 908 of the mill charge 904 is depicted. The impact angle 910 is also depicted, which is adjacent the cascade crushing zone 609 of FIG. 6. In the aspect depicted in FIG. 9, the pool 914 is also depicted, which can be a liquid portion of the mill charge, with an upper portion of the pool 914 indicated as a pool angle 912. The cascading motion 916 of the mill charge and/or the mill charge media sensor elements is schematically depicted as the plurality of circles 920.

In various aspects, as discussed above, the shell sensor assemblies can transmit or communicate the process data and/or sensed data (from the shell sensor assemblies and/or the mill charge media sensor elements) to a receiver, e.g., the receiver 130. As used herein, a receiver is broadly described and can include, not only a component for receiving the process data and/or sensed data communicated by the shell sensor assemblies, but also other computing device components for processing the received data, e.g., to generate two-dimensional process maps and/or three-dimensional process maps.

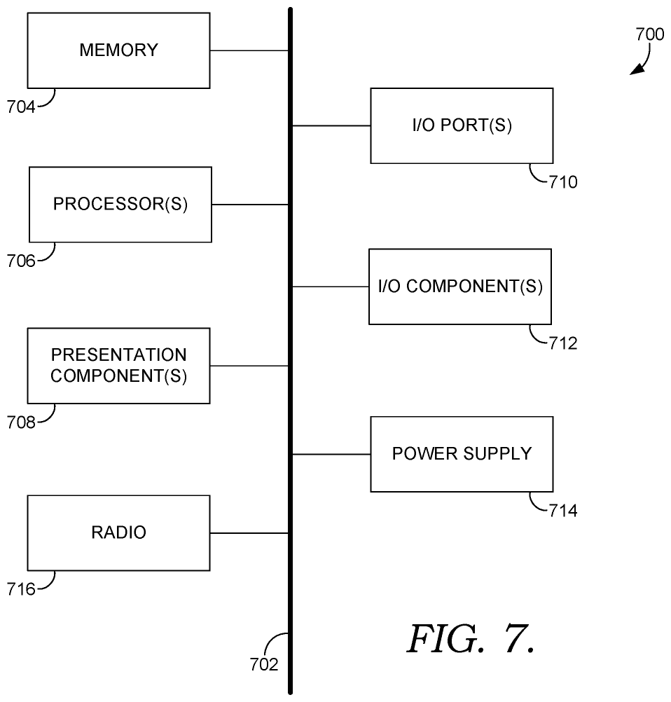

FIG. 7 depicts a computing device 700 and/or computing environment that, in aspects, can represent a receiver as described herein, and suitable for use in the methods and systems disclosed herein. The example computing environment is shown and designated generally as computing device 700. Computing device 700 is but one example of a suitable computing environment and is not intended to suggest any limitation as to the scope of use or functionality of the disclosure herein. Neither should computing device 700 be interpreted as having any dependency or requirement relating to any one or combination of components illustrated.

In certain aspects, implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a network.

With continued reference to FIG. 7, the computing device 700 includes a bus 702 that directly or indirectly couples the following devices: memory 704, one or more processors 706, one or more presentation components 708, radio 716, input/output (I/O) ports 710, I/O components 712, and a power supply 714. The bus 702 represents what may be one or more busses (such as an address bus, data bus, or combination thereof). Although the devices of FIG. 7 are shown with lines for the sake of clarity, in reality, delineating various components is not so clear, and metaphorically, the lines would more accurately be grey and fuzzy. For example, one may consider a presentation component such as a display device to be one of the I/O components 712. Also, processors, such as one or more processors 706, have memory. The present disclosure recognizes that such is the nature of the art, and reiterates that FIG. 7 is merely illustrative of an example computing environment that can be used in connection with one or more implementations of the present disclosure. Distinction is not made between such categories as “workstation,” “server,” “laptop,” “handheld device,” etc., as all are contemplated within the scope of FIG. 7 and refer to “computer” or “computing device.”

The computing device 700 typically includes a variety of computer-readable media. Computer-readable media can be any available media that can be accessed by the computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 704 includes computer-storage media in the form of volatile and/or nonvolatile memory. The memory 704 may be removable, nonremovable, or a combination thereof. Exemplary memory includes solid-state memory, hard drives, optical-disc drives, etc. The computing device 700 includes one or more processors 706 that read data from various entities such as bus 702, the memory 704 or the I/O components 712. One or more presentation components 708 presents data indications to a person or other device, in aspects. Exemplary one or more presentation components 708 include a display device, speaker, printing component, vibrating component, etc. The I/O ports 710 allow the computing device 700 to be logically coupled to other devices including the I/O components 712, some of which may be built in the computing device 700. Illustrative I/O components 712 include a receiver for receiving communications, microphone, joystick, game pad, satellite dish, scanner, printer, wireless device, etc. In aspects, the receiver can use any type of wired or wireless communication protocols including Bluetooth, Wi-Fi, NFC, wireless telecommunication protocols, e.g., 3G, 4G, 5G, etc.

The radio 716 represents a component that facilitates wireless communication, in aspects. Illustrative wireless communication technologies include Wi-Fi, 3G, 4G, 5G, Bluetooth, NFC, VoIP, and the like.

In various aspects, the receiver or other computing device or component can be configured to receive sensor data indicative of at least one pulp slurry zone of a mill charge within the mill grinding compartment. In certain aspects, the receiver or other computing device or component can be configured to receive sensor data indicative of at least one cascade crushing zone of a mill charge within the mill grinding compartment. In various aspects, the receiver or other computing device or component can be configured to receive sensor data indicative of at least one impact toe angle of a mill charge within the mill grinding compartment. In various aspects, the receiver or other computing device or component can be configured to receive sensor data indicative of at least one bulk toe angle within the mill grinding compartment. In various aspects, the receiver or other computing device or component can be configured to receive sensor data indicative of at least one cascade abrasion zone within the mill grinding compartment. In various aspects, the receiver or other computing device or component can be configured to receive sensor data indicative of at least one locked charge zone within the mill grinding compartment. In certain aspects, the receiver or other computing device or component can be configured to receive sensor data indicative of at least one departure zone within the mill grinding compartment. In various aspects, the receiver or other computing device or component can be configured to receive sensor data indicative of at least one shoulder angle within the mill grinding compartment. In one or more aspects, the receiver or other computing device or component can be configured to receive sensor data indicative of at least one head angle within the mill grinding compartment. In various aspects, the receiver or other computing device or component can be configured to receive sensor data indicative of at least one dead zone within the mill grinding compartment. In various aspects, the receiver or other computing device or component can be configured to receive sensor data indicative of at least one cataract zone within the mill grinding compartment.

In aspects, as discussed above, one or more the shell sensor assemblies can communicate to a receiver the sensed data, process data, or both from the shell sensor assemblies, and/or the sensed data, process data, or both received from the mill charge media sensor elements. The receiver and/or other computing device may be configured to construct a two-dimensional process map of the mill, a three-dimensional process map of the mill, or both, based on sensed data, process data, or both from the shell sensor assemblies, and/or the sensed data, process data, or both received from the mill charge media sensor elements. Further, in one or more aspects, the receiver and/or other computing device may be configured to calculate at least one trajectory of at least a portion of a mill charge, a mill charge media sensor element, or both based on sensed data, process data, or both from the shell sensor assemblies, and/or the sensed data, process data, or both received from the mill charge media sensor elements.

In certain aspects, the two-dimensional process map and/or the three-dimensional process map can include any or all of the sensed data or process data from the shell sensor assemblies and/or the mill charge media sensor elements. In various aspects, the two-dimensional process map and/or the three-dimensional process map can include a depiction of an axial flow profile of the mill charge and/or of one or more mill charge media sensor elements. In aspects, the axial flow profile can include a trend line and/or depiction of one or more mill charge feature or zone in various axial measurement zones, e.g., to provide an axial flow profile of the mill charge between the feed end and discharge end of the comminution mill grinding compartment. In one or more aspects, the two-dimensional process map and/or the three-dimensional process map can depict a profile and/or trend line of a position of a head angle, bulk toe angle, or other mill charge feature or zone in a plurality of adjacent axial measurement zones extending from a feed end to a discharge end of a comminution mill grinding compartment. In various aspects, the receiver and/or other computing device can link radial measurement zone data, e.g., shoulder angles, head angles, bulk charges, toe angles, impact data, and/or impact charge toe angle across the axial mill measurement zones, e.g., the feed end zone, the feed end middle zone, middle zone, discharge end middle zone, and the discharge end zone to provide a process map depicting the axial flow of the mill charge.

In one or more aspects, the two-dimensional process map and/or the three-dimensional process map can include one or more parameters calculated or estimated by the receiver and/or another computing device. For instance, in certain aspects, a calculated or estimated trajectory for at least a portion of the mill charge and/or of one or more mill charge media sensor elements can be included in a two-dimensional process map and/or the three-dimensional process map. In the same or alternative aspects, the receiver and/or other computing device can utilize the sensed data to calculate a mill charge volume. It should be understood that other calculations may be determined and/or performed by the receiver and/or other computing device, including calculations completed by shell sensor assemblies and/or a mill charge media sensor elements. A non-limiting list of calculations and/or estimations based on the sensed data can include trajectory of an object, mill charge volume, spin rate of an object, and angular speed of an object.

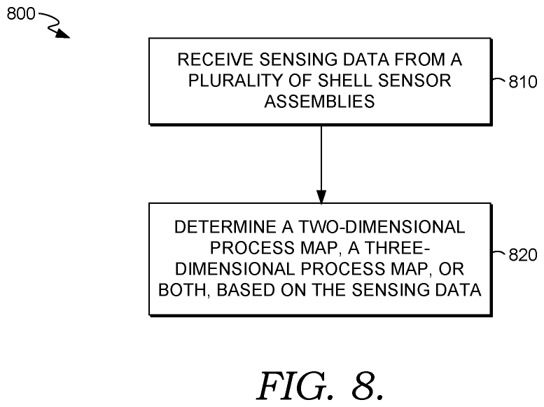

FIG. 8 is a flow diagram of an example method. The method 800 includes the step 810 of receiving sensing data from a plurality of shell sensor assemblies. In aspects, the step 810 of receiving sensing data can be performed by a receiver, such as, for example, the receiver 130 described above. In aspects, the sensing data can include data from a plurality of shell sensor assemblies during operation of a comminution mill. In certain aspects, the shell sensor assemblies can include any or all of the properties and parameters of the shell sensor assemblies disclosed herein. For instance, in certain aspects, the shell sensor assemblies can include one or more sensors or sensor array, an energy source, and at least one antenna. In various aspects, the shell sensor assemblies can include: at least one Radio frequency Identification (RFID) sensor, at least one inertial measurement unit (IMU), where the IMU comprises an accelerometer sensor and/or a gyroscope sensor, at least one magnetic sensor, at least one absolute position sensor, at least one angular speed sensor, at least one impact sensor, or any combination thereof. In certain aspects, the sensing data received from the plurality of shell sensor assemblies can also or alternatively include process data detected by the shell sensor assemblies, including, but not limited to, rotational velocity and/or angular speed of the comminution mill, absolute position, temperature, pressure, humidity, or a combination thereof.

In certain aspects, as discussed above, the shell sensor assemblies are adapted to receive sensed data and/or process data from one or more mill charge media sensor elements. In such aspects, the shell sensor assemblies can communicate the sensed data, process data, or both from the shell sensor assemblies, and/or the sensed data, process data, or both received from the mill charge media sensor elements to the receiver. The sensed data and/or process data from the mill charge media sensor elements can include any or all of the properties and/or parameters disclosed herein.

The method 800 also includes the step 820 of determining a two-dimensional process map, a three-dimensional process map, or both based on the sensing data. In one or more aspects, a receiver can perform all or a portion of the step 820. As discussed above, the receivers disclosed herein can not only include a component for receiving data from a plurality of shell sensor assemblies but can also include any type of computing device and/or computing device components.

In various aspects, a two-dimensional process map can be based on sensed data from the plurality of shell sensor assemblies, sensed data from the mill charge media sensor elements, or both. In the same or alternative aspects, a three-dimensional process map can be based on sensed data from the plurality of shell sensor assemblies, sensed data from the mill charge media sensor elements, or both. In certain aspects, the two-dimensional process map may include sensed data from one or more mill interior measurement zones, as discussed above. For instance, in one or more aspects, the two-dimensional process map may include sensed data from one or more axial measurement zones or one or more radial measurement zones. In various aspects, the three-dimensional process map can include sensed data from one or more mill interior measurement zones, as discussed above. For instance, in one or more aspects, the three-dimensional process map may include sensed data from one or more axial measurement zones and one or more radial measurement zones.

As discussed above, in certain aspects, the two-dimensional process map and/or the three-dimensional process map can include any or all of the sensed data or process data from the shell sensor assemblies and/or the mill charge media sensor elements. For example, as discussed above, the two-dimensional process map and/or the three-dimensional process map can include a trend line and/or depiction of the one or more mill charge feature or zone in various axial measurement zones, e.g., to provide an axial flow profile of the mill charge. For instance, in certain aspects, a two-dimensional process map and/or a three-dimensional process map can depict a profile and/or trend line of a position of a head angle, bulk toe angle, or other mill charge feature or zone in a plurality adjacent axial measurement zones extending from a feed end to a discharge end of a comminution compartment. As discussed above, the receiver or other computing component can link radial measurement zone data, e.g., shoulder angles, head angles, bulk charges, toe angles, impact data, and/or impact charge toe angle across the axial mill measurement zones, e.g., the feed end zone, the feed end middle zone, middle zone, discharge end middle zone, and the discharge end zone to provide a process map depicting the axial flow of the mill charge.

In certain aspects, the two-dimensional process map and/or the three-dimensional process map can include one or more parameters calculated or estimated by the receiver and/or another computing device. For instance, in certain aspects, a calculated or estimated trajectory for at least a portion of the mill charge and/or of one or more mill charge media sensor elements can be included in a two-dimensional process map and/or the three-dimensional process map. In the same or alternative aspects, the receiver and/or other computing device can utilize the data for an axial flow process map to calculate the mill charge volume.

In various aspects, the method 800 can also include displaying one or more two-dimensional process map, one or more three-dimensional process map or both. In certain aspects, the method 800 can also include providing an indication that based on the sensed data and/or one or more two-dimensional process map, one or more three-dimensional process map, or both, to adjust the mill charge feed rate or other comminution mill parameter to optimize the comminution operation.

The present disclosure can be described in accordance with the following numbered clauses.

Clause 1. A comminution mill sensor system, comprising: a plurality of shell sensor assemblies, wherein each of the plurality of shell sensor assemblies comprises: at least one sensor or sensor array, at least one energy source, and at least one antenna, wherein each of the plurality of shell sensor assemblies is coupled to a comminution mill grinding compartment, and wherein the plurality of shell sensor assemblies are adapted to provide for a plurality of mill interior measurement zones within the comminution mill grinding compartment.

Clause 2. The comminution mill sensor system according to clause 1, wherein each of the plurality of shell sensor assemblies is spaced apart so as to provide the plurality of mill interior measurement zones.

Clause 3. The comminution mill sensor system according to clauses 1 or 2, wherein the plurality of mill interior measurement zones comprise at least two axial measurement zones.

Clause 4. The comminution mill sensor system according to clause 3, wherein the plurality of mill interior measurement zones further comprise at least four radial measurement zones.

Clause 5. The comminution mill sensor system according to clauses 3 or 4, wherein the at least two axial measurement zones are located between a feed end of the comminution mill grinding compartment and a discharge end of the comminution mill grinding compartment.

Clause 6. The comminution mill sensor system according to any of clauses 3-5, wherein the at least two axial measurement zones comprise a substantially equal arrangement of zones distributed along substantially a length of the comminution mill grinding compartment.

Clause 7. The comminution mill sensor system according to any of clauses 4-6, wherein the at least four radial measurement zones comprise zones within a cross-section of the comminution mill grinding compartment, the zones comprising: a first radial zone including an open portion of a mill charge; a second radial zone including a toe portion of a mill charge; a third radial zone including a kidney portion of a mill charge; and a fourth radial zone including a shoulder portion of a mill charge.

Clause 8. The comminution mill sensor system according to any of clauses 1-7, wherein the at least one sensor or sensor array is operable to communicate sensor data wirelessly via the at least one antenna to at least one receiver positioned outside the comminution mill grinding compartment.

Clause 9. The comminution mill sensor system according to clause 8, wherein the at least one receiver is configured to receive sensor data indicative of: at least one pulp slurry zone of a mill charge within the comminution mill grinding compartment, at least one cascade crushing zone of a mill charge within the comminution mill grinding compartment, at least one impact charge toe angle of a mill charge within the comminution mill grinding compartment, at least one bulk charge toe angle of a mill charge within the comminution mill grinding compartment, at least one cascade abrasion zone of a mill charge within the comminution mill grinding compartment, at least one locked charge zone of a mill charge within the comminution mill grinding compartment, at least one departure zone of a mill charge within the comminution mill grinding compartment, at least one shoulder angle of a mill charge within the comminution mill grinding compartment, at least one head angle of a mill charge within the comminution mill grinding compartment, at least one dead zone of a mill charge within the comminution mill grinding compartment, at least one cataract zone of a mill charge within the comminution mill grinding compartment, or a combination thereof.

Clause 10. The comminution mill sensor system according to any of clauses 1-9, wherein the at least one sensor or sensor array comprises at least one Radio Frequency Identification (RFID) sensor, at least one inertial measurement unit (IMU), wherein the IMU comprises at least an accelerometer sensor and a gyroscope sensor, at least one magnetic sensor, at least one absolute position sensor, at least one angular speed sensor, at least one impact sensor, or a combination thereof.

Clause 11. The comminution mill sensor system according to any of clauses 1-10, wherein at least a portion of the plurality of shell sensor assemblies are configured to sense impact data, sense absolute position, sense absolute position of impact data, or a combination thereof.

Clause 12. The comminution mill sensor system according to any of clauses 1-11, further including a plurality of mill charge media sensor elements positioned within the comminution mill grinding compartment, each of the mill charge media sensor elements equipped with at least one energy source, at least one antenna, at least one RFID sensor, at least one accelerometer sensor at least one temperature sensor, or a combination thereof.

Clause 13. The comminution mill sensor system according to clause 12, wherein the plurality of mill charge media sensor elements is operable to wirelessly communicate RFID data, accelerometer data, temperature data, or a combination thereof, to at least one of the plurality of shell sensor assemblies while the plurality of mill charge media sensor elements are within a zone of detection of a shell sensor assembly of the plurality of shell sensor assemblies.

Clause 14. The comminution mill sensor system according to clause 8, wherein each of the plurality of shell sensor assemblies is configured for receiving process data from within the comminution mill grinding compartment and transmitting the process data to the at least one receiver.

Clause 15. The comminution mill sensor system according to any of clauses 1-14, wherein the plurality of shell sensor assemblies are configured to receive RFID data, accelerometer G-Force data, accelerometer spin data, temperature data, or a combination thereof, from one or more mill charge media sensor elements.

Clause 16. The comminution mill sensor system according to any of clauses 1-15, wherein each shell sensor assembly of the plurality of shell sensor assemblies is configured with a data relay mode to receive data broadcast from one or more mill charge media sensor elements while the one or more mill charge media sensor elements are within an axial zone of detection.

Clause 17. The comminution mill sensor system according to clause 16, wherein an association of the shell sensor assembly data, proximate mill charge media sensor element data, and optionally absolute position data, provides an indication of an axial zone location of a mill charge media sensor element of the one or more mill charge media sensor elements.

Clause 18. The comminution mill sensor system according to clause 12, wherein at least one shell sensor assembly of the plurality of shell sensor assemblies is operable to detect a mill charge media sensor element of the plurality of mill charge media sensor elements positioned within about 150 centimeters (cm) or less proximate to the at least one shell sensor assembly and/or to the at least one antenna of the at least one shell sensor assembly.

Clause 19. The comminution mill sensor system according to clause 12, wherein each of the plurality of shell sensor assemblies is configured to relay data from one or more mill charge media sensor elements to at least one receiver positioned outside the comminution mill grinding compartment.

Clause 20. The comminution mill sensor system according to clause 19, wherein the at least one receiver is configured to construct a three-dimensional process map of the comminution mill grinding compartment based on data from the plurality of mill charge media sensor elements, data from the plurality of shell sensor assemblies, or both.

Clause 21. The comminution mill sensor system according to clause 19, wherein the at least one receiver is configured to calculate at least one trajectory of at least one mill charge media sensor element of the plurality of mill charge media sensor elements based on data from the at least one mill charge media sensor element, data from at least one shell sensor assembly of the plurality of shell sensor assemblies, or both.

Clause 22. The comminution mill sensor system according to any of clauses 1-21, wherein for each of the plurality of shell sensor assemblies, the at least one antenna extends through a shell of the comminution mill grinding compartment.

Clause 23. The comminution mill sensor system according to any of clauses 1-22 further comprising a processor communicatively coupled with a receiver, wherein the receiver is configured to receive mill charge media sensor element data, shell sensor assembly data, or both.

Clause 24. The comminution mill sensor system according to any of clauses 1-23, wherein each of the plurality of shell sensor assemblies is coupled to a shell associated with the comminution mill grinding compartment, a shell liner associated with the comminution grinding compartment, a liner bolt associated with the comminution grinding compartment, or a combination thereof.

Clause 25. The comminution mill sensor system according to any of clauses 1-24, wherein at least a portion of the plurality of shell sensor assemblies is coupled to an exterior portion of the comminution mill grinding compartment.

Clause 26. The comminution mill sensor system according to any of clauses 1-25, wherein at least a portion of the plurality of shell sensor assemblies is coupled to an interior portion of the comminution mill grinding compartment.

Clause 27. The comminution mill sensor system according to any of clauses 1-26, wherein each of plurality of shell sensor assemblies is coupled to an interior portion of the comminution mill grinding compartment and/or to an exterior portion of the comminution mill grinding compartment.

Clause 28. A method for monitoring comminution mill operation conditions, comprising: receiving sensing data from a plurality of shell sensor assemblies during operation of a comminution mill, wherein each of the plurality of shell sensor assemblies comprise at least one sensor or sensor array, at least one energy source, and at least one antenna, and wherein each of the plurality of shell sensor assemblies is coupled to a comminution mill grinding compartment of the comminution mill, at spaced apart positions so as to provide a plurality of mill interior measurement zones; and determining a two-dimensional process map, a three-dimensional process map, or both, based on the sensing data.

Clause 29. The method according to clause 28, wherein the receiving sensing data comprises transmitting the sensing data from the plurality of shell sensor assemblies to one or more receivers positioned outside of an interior of the comminution mill grinding compartment.

Clause 30. The method according to clauses 28 or 29, wherein the sensing data comprises data associated with: at least one pulp slurry zone of a mill charge within the comminution mill grinding compartment, at least one cascade crushing zone of a mill charge within the comminution mill grinding compartment, at least one impact charge toe angle of a mill charge within the comminution mill grinding compartment, at least one bulk charge toe angle of a mill charge within the comminution mill grinding compartment, at least one cascade abrasion zone of a mill charge within the comminution mill grinding compartment, at least one locked charge zone of a mill charge within the comminution mill grinding compartment, at least one departure zone of a mill charge within the comminution mill grinding compartment, at least one shoulder angle of a mill charge within the comminution mill grinding compartment, at least one head angle of a mill charge within the comminution mill grinding compartment, at least one dead zone of a mill charge within the comminution mill grinding compartment, at least one cataract zone of a mill charge within the comminution mill grinding compartment, or a combination thereof.

Clause 31. The method according to any of clauses 28-30, wherein the sensing data comprises impact data, absolute position data, absolute position of impact data, or a combination thereof.

Clause 32. The method according to any of clauses 28-31, wherein the plurality of mill interior measurement zones comprise at least two axial measurement zones.

Clause 33. The method according to any of clauses 28-32, wherein the at least two axial measurement zones are located between the feed end of the comminution mill grinding compartment and the discharge end of the comminution mill grinding compartment.

Clause 34. The method according to any of clauses 28-33, wherein the plurality of mill interior measurement zones comprise at least four radial measurement zones, wherein the at least four radial measurement zones comprise zones within a cross-section of the comminution mill grinding compartment.

Clause 35. The method according to clause 34, wherein the zones within the cross-section of the comminution mill grinding compartment comprise: a first radial zone including an open portion of a mill charge; a second radial zone including a toe portion of a mill charge; a third radial zone including a kidney portion of a mill charge; and a fourth radial zone including a shoulder portion of a mill charge.

Clause 36. The method according to any of clauses 28-35, wherein the receiving sensing data comprises receiving sensing data wirelessly via the at least one antenna of each of the plurality of shell sensor assemblies, to a receiver positioned outside the comminution mill grinding compartment.

Clause 37. The method according to any of clauses 28-36, wherein the sensing data comprises sensing data from one or more mill charge media sensor elements positioned within the interior of the comminution mill grinding compartment.

Clause 38. The method according to clause 37, wherein each of the one or more mill charge media sensor elements are equipped with at least one energy source, at least one antenna, at least one RFID sensor, at least one accelerometer sensor, at least one temperature sensor, or a combination thereof.

Clause 39. The method according to clause 37 or 38, wherein each of the one or more mill charge media sensor elements is operable to wirelessly communicate RFID data, accelerometer data, temperature data, or a combination thereof, to at least one of the plurality of shell sensor assemblies while the one or more mill charge media sensor elements are within a zone of detection of the at least one of the plurality of shell sensor assemblies.

Clause 40. The method according to any of clauses 37-39, wherein the plurality of shell sensor assemblies are configured to receive RFID data, accelerometer G-Force data, accelerometer spin data, temperature data, or a combination thereof from the one or more mill charge media sensor elements.

Clause 41. The method according to any of clauses 37-40, wherein each shell sensor assembly of the plurality of shell sensor assemblies is configured with a data relay mode to receive data broadcast from the one or more mill charge media sensor elements while the one or more mill charge media sensor elements are within an axial zone of detection.

Clause 42. The method according to any of clauses 37-41, wherein an association of the shell sensor assembly data, proximate mill charge media sensor element data, and optionally absolute position data, provides an indication of an axial zone location of a grinding media element of the one or more mill charge media sensor elements.

Clause 43. The method according to any of clauses 37-42, wherein at least one shell sensor assembly of the plurality of shell sensor assemblies detects a mill charge media sensor element positioned within about 500 millimeters or less proximate to the at least one shell sensor assembly.

Clause 44. The method according to any of clauses 37-43, wherein each of the plurality of shell sensor assemblies relays data from the one or more mill charge media sensor elements to at least one receiver positioned outside of the mill grinding compartment.

Clause 45. The method according to any of clauses 37-44, wherein the determining the two-dimensional process map, the three-dimensional process map, or both comprises determining the two-dimensional process map, the three-dimensional process map, or both, based on: the sensed data from the plurality of shell sensor assemblies; data from the one or more mill charge media sensor elements; or both.

Clause 46. The method according to any of clauses 37-45, further comprising calculating a trajectory of at least one mill charge media sensor element of the one or more mill charge media sensor elements based on: the sensed data from the plurality of shell sensor assemblies; data from the one or more mill charge media sensor elements; or both.

Clause 47. The comminution mill sensor system according to any of clauses 28-46, wherein each of the plurality of shell sensor assemblies is coupled to a shell associated with the comminution mill grinding compartment, a shell liner associated with the comminution grinding compartment, a liner bolt associated with the comminution grinding compartment, or a combination thereof.

Clause 48. The comminution mill sensor system according to any of clauses 28-47, wherein at least a portion of the plurality of shell sensor assemblies is coupled to an exterior portion of the comminution mill grinding compartment.

Clause 49. The comminution mill sensor system according to any of clauses 28-48, wherein at least a portion of the plurality of shell sensor assemblies is coupled to an interior portion of the comminution mill grinding compartment.

Clause 50. The comminution mill sensor system according to any of clauses 28-49, wherein each of the plurality of shell sensor assemblies is coupled to an interior portion of the comminution mill grinding compartment and/or to an exterior portion of the comminution mill grinding compartment.

Clause 51. A comminution mill sensor system for calculating the trajectory of at least one mill charge media sensor element within a comminution mill compartment, the comminution mill sensor system comprising: at least one shell sensor assembly, the at least one shell sensor assembly comprising: at least one energy source; at least one sensor array situated inside the at least one shell sensor assembly, wherein the at least one sensor array is configured to detect information at least indicative of a time-indexed presence of the at least one mill charge media sensor element within at least one zone of detection within at least one measurement zone corresponding to a portion of the comminution mill compartment; a processor operably coupled with a memory configured for storing instructions that when executed configure the processor to calculate at least one trajectory information value from the information at least indicative of a time-indexed presence of the at least one mill charge media sensor element within the at least one zone of detection, the memory further configured to at least temporarily store the trajectory information value of the mill charge media sensor element; and at least one antenna connected to the at least one sensor array.

Clause 52. The comminution mill sensor system according to clause 51, wherein the processor is positioned within the at least one shell sensor assembly, the at least one mill charge media sensor element, or outside of the comminution mill compartment.

Clause 53. The comminution mill sensor system of clauses 51 or 52, wherein the at least one measurement zone comprises a two-dimensional data set, the two-dimensional data set being indicative of a radial zone of detection or an axial zone of detection within the comminution mill compartment.

Clause 54. The comminution mill sensor system of any of clauses 51-53, wherein the at least one measurement zone comprises a three-dimensional data set, the three-dimensional data set being indicative of a radial zone of detection and an axial zone of detection within the comminution mill compartment.

Clause 55. A comminution mill sensor system comprising: at least one array of shell sensors distributed around a comminution mill compartment, the array of shell sensors configured to sense location and motion data from a plurality of mill charge media sensor elements, wherein the at least one array of shell sensors is configured to define a set of detection zones arranged both radially and axially within the comminution mill compartment; and at least one processor configured to compute trajectory data based on location and motion data received from at least a portion of the at least one array of shell sensors, the plurality of mill charge media elements, or both.

Clause 56. A method for computing comminution mill grinding media trajectory comprising: sensing location and motion data from a plurality of mill charge media sensor elements at an array of shell sensor assemblies; calculating mill charge media sensor element position within a mill grinding compartment in real-time; computing trajectory data based on real-time mill charge media element position calculations; and transmitting the trajectory data to a remote receiver.

Clause 57. The method of clause 48, wherein the real-time mill charge media element position calculations are performed by an edge processor positioned at a hub proximate to at least one receiver situated outside the mill grinding compartment.

This disclosure has been described in detail with particular reference to specific aspects thereof, but it will be understood that variations and modifications can be made within the spirit and scope of this disclosure.

1. A comminution mill sensor system, comprising:
a plurality of shell sensor assemblies, wherein each of the plurality of shell sensor assemblies comprises:
at least one sensor or sensor array, at least one energy source, and at least one antenna, wherein each of the plurality of shell sensor assemblies is coupled to a comminution mill grinding compartment, and wherein the plurality of shell sensor assemblies are adapted to provide for a plurality of mill interior measurement zones for a mill charge within the comminution mill grinding compartment.

2. The comminution mill sensor system according to claim 1, wherein each of the plurality of shell sensor assemblies is spaced apart so as to provide the plurality of mill interior measurement zones.

3. The comminution mill sensor system according to claim 1, wherein the plurality of mill interior measurement zones comprise at least two axial measurement zones.

4. The comminution mill sensor system according to claim 3, wherein the plurality of mill interior measurement zones further comprise at least four radial measurement zones.

5. The comminution mill sensor system according to claim 3, wherein the at least two axial measurement zones are located between a feed end of the comminution mill grinding compartment and a discharge end of the comminution mill grinding compartment.

6. The comminution mill sensor system according to claim 3, wherein the at least two axial measurement zones comprise a substantially equal arrangement of zones distributed along substantially a length of the comminution mill grinding compartment.

7. The comminution mill sensor system according to claim 4, wherein the at least four radial measurement zones comprise zones within a cross-section of the comminution mill grinding compartment, the zones comprising:
a first radial zone including an open portion of a mill charge;
a second radial zone including a toe portion of a mill charge;
a third radial zone including a kidney portion of a mill charge; and
a fourth radial zone including a shoulder portion of a mill charge.

8. The comminution mill sensor system according to claim 1, wherein the at least one sensor or sensor array is operable to communicate sensor data wirelessly via the at least one antenna to at least one receiver positioned outside the comminution mill grinding compartment.

9. The comminution mill sensor system according to claim 8, wherein the at least one receiver is configured to receive sensor data indicative of: at least one pulp slurry zone of a mill charge within the comminution mill grinding compartment, at least one cascade crushing zone of a mill charge within the comminution mill grinding compartment, at least one impact charge toe angle of a mill charge within the comminution mill grinding compartment, at least one bulk charge toe angle of a mill charge within the comminution mill grinding compartment, at least one cascade abrasion zone of a mill charge within the comminution mill grinding compartment, at least one locked charge zone of a mill charge within the comminution mill grinding compartment, at least one departure zone of a mill charge within the comminution mill grinding compartment, at least one shoulder angle of a mill charge within the comminution mill grinding compartment, at least one head angle of a mill charge within the comminution mill grinding compartment, at least one dead zone of a mill charge within the comminution mill grinding compartment, at least one cataract zone of a mill charge within the comminution mill grinding compartment, or a combination thereof.

10. The comminution mill sensor system according to claim 1, wherein the at least one sensor or sensor array comprises at least one Radio Frequency Identification (RFID) sensor, at least one inertial measurement unit (IMU), wherein the IMU comprises at least an accelerometer sensor and a gyroscope sensor, at least one magnetic sensor, at least one absolute position sensor, at least one angular speed sensor, at least one impact sensor, or a combination thereof.

11. The comminution mill sensor system according to claim 1, wherein at least a portion of the plurality of shell sensor assemblies are configured to sense impact data, sense absolute position, sense absolute position of impact data, or a combination thereof.

12. The comminution mill sensor system according to claim 1, further including a plurality of mill charge media sensor elements positioned within the comminution mill grinding compartment, each of the mill charge media sensor elements equipped with at least one energy source, at least one antenna, at least one RFID sensor, at least one accelerometer sensor at least one temperature sensor, or a combination thereof.

13. The comminution mill sensor system according to claim 12, wherein the plurality of mill charge media sensor elements is operable to wirelessly communicate RFID data, accelerometer data, temperature data, or a combination thereof, to at least one of the plurality of shell sensor assemblies while the plurality of mill charge media sensor elements are within a zone of detection of a shell sensor assembly of the plurality of shell sensor assemblies.

14. The comminution mill sensor system according to claim 8, wherein each of the plurality of shell sensor assemblies is configured for receiving process data from within the comminution mill grinding compartment and transmitting the process data to the at least one receiver.

15. The comminution mill sensor system according to claim 1, wherein the plurality of shell sensor assemblies are configured to receive RFID data, accelerometer G-Force data, accelerometer spin data, temperature data, or a combination thereof, from one or more mill charge media sensor elements.

16. The comminution mill sensor system according to claim 1, wherein each shell sensor assembly of the plurality of shell sensor assemblies is configured with a data relay mode to receive data broadcast from one or more mill charge media sensor elements while the one or more mill charge media sensor elements are within an axial zone of detection.

17. The comminution mill sensor system according to claim 16, wherein an association of the shell sensor assembly data, proximate mill charge media sensor element data, and optionally absolute position data, provides an indication of an axial zone location of a mill charge media sensor element of the one or more mill charge media sensor elements.

18. The comminution mill sensor system according to claim 12, wherein at least one shell sensor assembly of the plurality of shell sensor assemblies is operable to detect a mill charge media sensor element of the plurality of mill charge media sensor elements positioned within about 150 centimeters (cm) or less proximate to the at least one shell sensor assembly and/or to the at least one antenna of the at least one shell sensor assembly.

19. The comminution mill sensor system according to claim 12, wherein each of the plurality of shell sensor assemblies is configured to relay data from one or more mill charge media sensor elements to at least one receiver positioned outside the comminution mill grinding compartment.

20. (canceled)

21. (canceled)

22. (canceled)

23. (canceled)

24. (canceled)

25. (canceled)

26. (canceled)

27. (canceled)

28. A method for monitoring comminution mill operation conditions, comprising:
receiving sensing data from a plurality of shell sensor assemblies during operation of a comminution mill, wherein each of the plurality of shell sensor assemblies comprise at least one sensor or sensor array, at least one energy source, and at least one antenna, and wherein each of the plurality of shell sensor assemblies is coupled to a comminution mill grinding compartment of the comminution mill, at spaced apart positions so as to provide a plurality of mill interior measurement zones for a mill charge; and
determining a two-dimensional process map, a three-dimensional process map, or both, based on the sensing data.

29-50. (canceled)
